(19) United States
(12) Patent Application Publication
(10) Pub. No.: US 2018/0324087 A1
(43) Pub. Date: Nov. 8, 2018

(54) METHOD AND SYSTEM FOR ROUTING RULE TRANSMISSION, AND DEVICE

(71) Applicant: HUAWEI TECHNOLOGIES CO., LTD., Shenzhen (CN)

(72) Inventors: Huan LI, Shanghai (CN); Youyang YU, Shanghai (CN)

(21) Appl. No.: 16/036,557

(22) Filed: Jul. 16, 2018

Related U.S. Application Data
(63) Continuation of application No. PCT/CN2016/087949, filed on Jun. 30, 2016.

(30) Foreign Application Priority Data
Jan. 19, 2016 (CN) PCT/CN2016/071388

(51) Int. Cl. H04L 12/721; H04W 76/16; H04M 15/00; H04W 36/00; H04W 36/14; H04W 88/16; H04W 88/06

(52) U.S. Cl. CPC H04L 45/38; H04W 76/16; H04M 15/66; H04W 84/12; H04W 36/14; H04W 88/16; H04W 88/06; H04W 36/0022

(57) ABSTRACT

Embodiments of the present application provide a method and a system for routing rule transmission, and a device. The method includes: sending, by a terminal, an NBIFOM routing rule request to a gateway device through an intermediate network device; sending, by the gateway device, at least one routing rule to the terminal through the intermediate network device according to the NBIFOM routing rule request; sending, by the terminal, routing rule acknowledgement indication information to the gateway device through the intermediate network device according to the at least one received routing rule; and determining, by the gateway device according to the routing rule acknowledgement indication information, a routing rule rejected by the terminal in the at least one routing rule, so that the gateway device transmits a traffic flow by using a routing rule other than the routing rule rejected by the terminal in the at least one routing rule.

### CROSS-REFERENCE TO RELATED APPLICATIONS

This application is a continuation of International Patent Application No. PCT/CN2016/087949, filed on Jun. 30, 2016, which claims priority to International Patent Application No. PCT/CN2016/071388, filed on Jan. 19, 2016, The disclosures of the aforementioned applications are hereby incorporated by reference in their entireties.

### TECHNICAL FIELD

Embodiments of the present application relate to the field of communications technologies, and in particular, to a method and a system for routing rule transmission, and a device.

### BACKGROUND

Currently, a third-generation partnership project (3GPP) standard protocol supports a terminal in simultaneously accessing a 3GPP network and a non-3GPP network. In addition, the terminal can access a same packet data network (PDN) connection through the 3GPP network and the non-3GPP network simultaneously, that is, the terminal can access a same packet data network gateway (PGW) simultaneously. In this way, different traffic flows in the same PDN connection may be distributed in the 3GPP network and the non-3GPP network, so that an objective of routing traffic flows between the terminal and the same PGW and properly using network resources is achieved. When the PGW supports the general packet radio service (GPRS) Tunneling Protocol (GTP) or the Proxy Mobile IP (PMIP) protocol, the foregoing feature of routing different traffic flows in the same PDN connection in the 3GPP network and the non-3GPP network is referred to as network based IP flow mobility (NBIFOM). NBIFOM modes may be classified into a network-initiated NBIFOM mode and a terminal-initiated NBIFOM mode. In the network-initiated NBIFOM mode, a routing rule for a traffic flow is determined by a network. In the terminal-initiated NBIFOM mode, a routing rule for a traffic flow is determined by the terminal. For example, in the network-initiated NBIFOM mode, the terminal may send an NBIFOM request to a network in any one of the following cases: The terminal requests to transmit some traffic flows in an access network; the terminal needs to report to the network when detecting that an access network is available or unavailable; or the terminal needs to send a radio access network (RAN) rule indication (including transfer from a wireless local area network (WLAN) or transfer to a WLAN) to the network.

In the prior art, when the terminal sends an NBIFOM request in the network-initiated NBIFOM mode, a routing rule transmission mode is as follows: The terminal sends a modify packet data protocol (PDP) context request to an intermediate network node (for example, a serving GPRS support node (SGSN)). The intermediate network node obtains a routing rule from a gateway device (for example, the PGW) according to the modify PDP context request sent by the terminal, and sends the routing rule to the terminal, and the routing rule transmission process ends. Then the network transmits a traffic flow according to the routing rule sent to the terminal.

However, if the terminal cannot enforce the routing rule after receiving the routing rule sent by the network, the traffic flow corresponding to the routing rule cannot be transmitted correctly.

### SUMMARY

Embodiments of the present application provide a method and a system for routing rule transmission, and a device, so as to ensure consistency of routing rules used by a gateway device and a terminal and ensure correct transmission of a traffic flow.

According to a first aspect, an embodiment of the present application provides a method for routing rule transmission, where the method includes: sending, by a terminal, an NBIFOM routing rule request to an intermediate network device, where the NBIFOM routing rule request includes a routing rule generation parameter; receiving K routing rules sent by the intermediate network device, where K is an integer greater than or equal to 1; and sending routing rule acknowledgement indication information to the intermediate network device, where the routing rule acknowledgement indication information includes at least one of the following: identifiers of M routing rules acknowledged by the terminal in the K routing rules and identifiers of N rejected routing rules, where a sum of M and N is equal to K. This ensures consistency of routing rules used by a gateway device and the terminal, and ensures correct transmission of a traffic flow.

In one embodiment, before the sending, by a terminal, an NBIFOM routing rule request to an intermediate network device, the method further includes: in a process of establishing a PDN connection between the terminal and a gateway device, sending, by the terminal, a PDN connection establishment request to the gateway device through the intermediate network device, where the PDN connection establishment request carries an NBIFOM mode indication, and the NBIFOM mode indication is used to indicate that a current NBIFOM mode is a network-initiated NBIFOM mode or a terminal-initiated NBIFOM mode, so that the intermediate network device records the current NBIFOM mode.

According to a second aspect, an embodiment of the present application provides a method for routing rule transmission, where the method includes: receiving, by an intermediate network device, an NBIFOM routing rule request sent by a terminal, and sending the NBIFOM routing rule request to a gateway device, where the NBIFOM routing rule request includes a routing rule generation parameter; receiving K routing rules that are generated by the gateway device according to the NBIFOM routing rule request, and sending the K routing rules to the terminal, where K is an integer greater than or equal to 1; and receiving routing rule acknowledgement indication information sent by the terminal, and sending the routing rule acknowledgement indication information to the gateway device, where the routing rule acknowledgement indication information includes at least one of the following: identifiers of M routing rules acknowledged by the terminal in the K routing rules and identifiers of N rejected routing rules, where a sum of M and N is equal to K. This ensures consistency of routing rules used by the gateway device and the terminal, and ensures correct transmission of a traffic flow.

In one embodiment, after the receiving, by an intermediate network device, an NBIFOM routing rule request sent by a terminal, the method further includes: sending a routing rule timing instruction to the gateway device; and after the receiving, by the intermediate network device, K routing rules that are generated by the gateway device according to the routing rule request, the method further includes: sending a routing rule reception response to the gateway device; where the routing rule timing instruction is used to instruct the gateway device to: start timing when the gateway device receives the routing rule reception response, and determine an enforceable routing rule according to the routing rule acknowledgement indication information if the routing rule acknowledgement indication information is received before a timing time reaches the preset time, or determine the K routing rules as enforceable routing rules if the routing rule acknowledgement indication information is not received before a timing time reaches the preset time.

In one embodiment, before the sending, by the intermediate network device, the K routing rules to the terminal, the method further includes: determining that the NBIFOM routing rule request is sent by the terminal in a network-initiated NBIFOM mode.

In one embodiment, before the receiving, by an intermediate network device, an NBIFOM routing rule request sent by a terminal, the method further includes: in a process of establishing a PDN connection between the terminal and the gateway device, receiving a PDN connection establishment request sent by the terminal to the gateway device, where the PDN connection establishment request includes an NBIFOM container, and the NBIFOM container carries an NBIFOM mode indication; or receiving a PDN connection establishment response sent by the gateway device to the terminal, where the PDN connection establishment response includes an NBIFOM container, and the NBIFOM container carries an NBIFOM mode indication; where the NBIFOM mode indication is used to indicate that a current NBIFOM mode is the network-initiated NBIFOM mode or a terminal-initiated NBIFOM mode;

parsing the NBIFOM container to obtain the NBIFOM mode indication; and recording the current NBIFOM mode according to the NBIFOM mode indication; and

the determining, by the intermediate network device, that the NBIFOM routing rule request is sent by the terminal in a network-initiated NBIFOM mode includes: determining, according to the current NBIFOM mode recorded as the network-initiated NBIFOM mode, that the NBIFOM routing rule request is sent by the terminal in the network-initiated NBIFOM mode.

In one embodiment, before the receiving, by an intermediate network device, an NBIFOM routing rule request sent by a terminal, the method further includes: in a process of establishing a PDN connection between the terminal and the gateway device, receiving a PDN connection establishment request sent by the terminal to the gateway device, where the PDN connection establishment request carries an NBIFOM mode indication; or receiving a PDN connection establishment response sent by the gateway device to the terminal, where the PDN connection establishment response carries an NBIFOM mode indication; where the NBIFOM mode indication is used to indicate that a current NBIFOM mode is the network-initiated NBIFOM mode or a terminal-initiated NBIFOM mode; and

recording the current NBIFOM mode according to the NBIFOM mode indication; and

the determining, by the intermediate network device, that the NBIFOM routing rule request is sent by the terminal in a network-initiated NBIFOM mode includes: determining, according to the current NBIFOM mode recorded as the network-initiated NBIFOM mode, that the NBIFOM routing rule request is sent by the terminal in the network-initiated NBIFOM mode.

In one embodiment, the NBIFOM routing rule request further includes a first indication, and the first indication is used to indicate whether a current access network is available to the terminal, or used to indicate that a traffic flow of the terminal in the current corresponding access network needs to be transferred from an RAN to a WLAN or from a WLAN to an RAN, or used to indicate that a type of the NBIFOM routing rule request is a traffic flow mapping request; and

the determining, by the intermediate network device, that the NBIFOM routing rule request is sent by the terminal in a network-initiated NBIFOM mode includes: determining, according to the first indication, that the NBIFOM routing rule request is sent by the terminal in the network-initiated NBIFOM mode.

According to a third aspect, an embodiment of the present application provides a method for routing rule transmission, where the method includes: receiving, by a gateway device, an NBIFOM routing rule request sent by an intermediate network device, where the NBIFOM routing rule request includes a routing rule generation parameter; generating K routing rules according to the NBIFOM routing rule request, where K is an integer greater than or equal to 1; sending the K routing rules to the intermediate network device; receiving routing rule acknowledgement indication information sent by the intermediate network device, where the routing rule acknowledgement indication information includes at least one of the following: identifiers of M routing rules acknowledged by a terminal in the K routing rules and identifiers of N rejected routing rules, where a sum of M and N is equal to K; and determining, according to the routing rule acknowledgement indication information, the N routing rules rejected by the terminal in the K routing rules. This ensures consistency of routing rules used by the gateway device and the terminal, and ensures correct transmission of a traffic flow.

In one embodiment, after the receiving, by a gateway device, an NBIFOM routing rule request sent by an intermediate network device, the method further includes: receiving a routing rule timing instruction sent by the intermediate network device;

after the sending, by the gateway device, the K routing rules to the intermediate network device, the method further includes: receiving a routing rule reception response sent by the intermediate network device; and starting timing according to the routing rule timing instruction when receiving the routing rule reception response; and

the receiving, by the gateway device, routing rule acknowledgement indication information sent by the intermediate network device includes: receiving the routing rule acknowledgement indication information before a timing time reaches a preset time.

In one embodiment, the method further includes: if the gateway device does not receive the routing rule acknowledgement indication information before the timing time reaches the preset time, determining that the K routing rules are enforceable routing rules.

In one embodiment, before the receiving, by a gateway device, an NBIFOM routing rule request sent by an intermediate network device, the method further includes: in a process of establishing a PDN connection between the gateway device and the terminal, sending a PDN connection establishment response to the terminal through the intermediate network device, where the PDN connection establishment response carries an NBIFOM mode indication, and the NBIFOM mode indication is used to indicate that a current NBIFOM mode is a network-initiated NBIFOM mode or a terminal-initiated NBIFOM mode, so that the intermediate network device records the current NBIFOM mode.

According to a fourth aspect, an embodiment of the present application provides a terminal, including: a sending unit, configured to send an NBIFOM routing rule request to an intermediate network device, where the NBIFOM routing rule request includes a routing rule generation parameter; and a receiving unit, configured to receive K routing rules sent by the intermediate network device, where K is an integer greater than or equal to 1; where the sending unit is further configured to send routing rule acknowledgement indication information to the intermediate network device, where the routing rule acknowledgement indication information includes at least one of the following: identifiers of M routing rules acknowledged by the terminal in the K routing rules and identifiers of N rejected routing rules, where a sum of M and N is equal to K.

In one embodiment, before sending the NBIFOM routing rule request to the intermediate network device, the sending unit is further configured to: in a process of establishing a PDN connection between the terminal and a gateway device, send a PDN connection establishment request to the gateway device through the intermediate network device, where the PDN connection establishment request carries an NBIFOM mode indication, and the NBIFOM mode indication is used to indicate that a current NBIFOM mode is a network-initiated NBIFOM mode or a terminal-initiated NBIFOM mode, so that the intermediate network device records the current NBIFOM mode.

According to a fifth aspect, an embodiment of the present application provides an intermediate network device, including: a receiving unit, configured to receive an NBIFOM routing rule request sent by a terminal, where the NBIFOM routing rule request includes a routing rule generation parameter; and a sending unit, configured to send the NBIFOM routing rule request to a gateway device; where the receiving unit is further configured to receive K routing rules that are generated by the gateway device according to the NBIFOM routing rule request, where K is an integer greater than or equal to 1; the sending unit is further configured to send the K routing rules to the terminal; the receiving unit is further configured to receive routing rule acknowledgement indication information sent by the terminal, where the routing rule acknowledgement indication information includes at least one of the following: identifiers of M routing rules acknowledged by the terminal in the K routing rules and identifiers of N rejected routing rules, where a sum of M and N is equal to K; and the sending unit is further configured to send the routing rule acknowledgement indication information to the gateway device. This ensures consistency of routing rules used by the gateway device and the terminal, and ensures correct transmission of a traffic flow.

In one embodiment, after the receiving unit receives the NBIFOM routing rule request sent by the terminal, the sending unit is further configured to send a routing rule timing instruction to the gateway device; and after the receiving unit receives the K routing rules that are generated by the gateway device according to the routing rule request, the sending unit is further configured to send a routing rule reception response to the gateway device; where the routing rule timing instruction is used to instruct the gateway device to: start timing when the gateway device receives the routing rule reception response, and determine an enforceable routing rule according to the routing rule acknowledgement indication information if the routing rule acknowledgement indication information is received before a timing time reaches the preset time, or determine the K routing rules as enforceable routing rules if the routing rule acknowledgement indication information is not received before a timing time reaches the preset time.

In one embodiment, the intermediate network device further includes: a processing unit, configured to determine, before the sending unit sends the K routing rules to the terminal, that the NBIFOM routing rule request is sent by the terminal in a network-initiated NBIFOM mode.

In one embodiment, before receiving the NBIFOM routing rule request sent by the terminal, the receiving unit is further configured to: in a process of establishing a PDN connection between the terminal and the gateway device, receive a PDN connection establishment request sent by the terminal to the gateway device, where the PDN connection establishment request includes an NBIFOM container, and the NBIFOM container carries an NBIFOM mode indication; or receive a PDN connection establishment response sent by the gateway device to the terminal, where the PDN connection establishment response includes an NBIFOM container, and the NBIFOM container carries an NBIFOM mode indication; where the NBIFOM mode indication is used to indicate that a current NBIFOM mode is the network-initiated NBIFOM mode or a terminal-initiated NBIFOM mode; the processing unit is further configured to parse the NBIFOM container to obtain the NBIFOM mode indication, and record the current NBIFOM mode according to the NBIFOM mode indication; and when determining that the NBIFOM routing rule request is sent by the terminal in the network-initiated NBIFOM mode, the processing unit is configured to determine, according to the current NBIFOM mode recorded as the network-initiated NBIFOM mode, that the NBIFOM routing rule request is sent by the terminal in the network-initiated NBIFOM mode.

In one embodiment, before receiving the NBIFOM routing rule request sent by the terminal, the receiving unit is further configured to: in a process of establishing a PDN connection between the terminal and the gateway device, receive a PDN connection establishment request sent by the terminal to the gateway device, where the PDN connection establishment request carries an NBIFOM mode indication; or receive a PDN connection establishment response sent by the gateway device to the terminal, where the PDN connection establishment response carries an NBIFOM mode indication; where the NBIFOM mode indication is used to indicate that a current NBIFOM mode is the network-initiated NBIFOM mode or a terminal-initiated NBIFOM mode; the processing unit is further configured to record the current NBIFOM mode according to the NBIFOM mode indication; and when determining that the NBIFOM routing rule request is sent by the terminal in the network-initiated NBIFOM mode, the processing unit is configured to determine, according to the current NBIFOM mode recorded as the network-initiated NBIFOM mode, that the NBIFOM routing rule request is sent by the terminal in the network-initiated NBIFOM mode.

In one embodiment, the NBIFOM routing rule request further includes a first indication, and the first indication is used to indicate whether a current access network is available to the terminal, or used to indicate that a traffic flow of the terminal in the current corresponding access network needs to be transferred from an RAN to a WLAN or from a WLAN to an RAN, or used to indicate that a type of the NBIFOM routing rule request is a traffic flow mapping request; and when determining that the NBIFOM routing rule request is sent by the terminal in the network-initiated NBIFOM mode, the processing unit is configured to determine, according to the first indication, that the NBIFOM routing rule request is sent by the terminal in the network-initiated NBIFOM mode.

According to a sixth aspect, an embodiment of the present application provides a gateway device, including: a receiving unit, configured to receive an NBIFOM routing rule request sent by an intermediate network device, where the NBIFOM routing rule request includes a routing rule generation parameter; a processing unit, configured to generate K routing rules according to the NBIFOM routing rule request, where K is an integer greater than or equal to 1; and a sending unit, configured to send the K routing rules to the intermediate network device; where the receiving unit is further configured to receive routing rule acknowledgement indication information sent by the intermediate network device, where the routing rule acknowledgement indication information includes at least one of the following: identifiers of M routing rules acknowledged by a terminal in the K routing rules and identifiers of N rejected routing rules, where a sum of M and N is equal to K; and the processing unit is further configured to determine, according to the routing rule acknowledgement indication information, the N routing rules rejected by the terminal in the K routing rules. This ensures consistency of routing rules used by the gateway device and the terminal, and ensures correct transmission of a traffic flow.

In one embodiment, after receiving the NBIFOM routing rule request sent by the intermediate network device, the receiving unit is further configured to receive a routing rule timing instruction sent by the intermediate network device; after the sending unit sends the K routing rules to the intermediate network device, the receiving unit is further configured to receive a routing rule reception response sent by the intermediate network device; the processing unit is further configured to start timing according to the routing rule timing instruction when the routing rule reception response is received; and when receiving the routing rule acknowledgement indication information sent by the intermediate network device, the receiving unit is specifically configured to receive the routing rule acknowledgement indication information before a timing time reaches a preset time.

In one embodiment, if determining that the receiving unit does not receive the routing rule acknowledgement indication information before the timing time reaches the preset time, the processing unit is further configured to determine that the K routing rules are enforceable routing rules.

In one embodiment, before the receiving unit receives the NBIFOM routing rule request sent by the intermediate network device, the sending unit is further configured to: in a process of establishing a PDN connection between the gateway device and the terminal, send a PDN connection establishment response to the terminal through the intermediate network device, where the PDN connection establishment response carries an NBIFOM mode indication, and the NBIFOM mode indication is used to indicate that a current NBIFOM mode is a network-initiated NBIFOM mode or a terminal-initiated NBIFOM mode, so that the intermediate network device records the current NBIFOM mode.

According to a seventh aspect, an embodiment of the present application provides a terminal, including a transmitter, a receiver, a processor, and a memory, where the memory is configured to store program code for performing a method for routing rule transmission; and the processor is configured to invoke the program code in the memory to perform: sending an NBIFOM routing rule request to an intermediate network device by using the transmitter, where the NBIFOM routing rule request includes a routing rule generation parameter; receiving, by using the receiver, K routing rules sent by the intermediate network device, where K is an integer greater than or equal to 1; and sending routing rule acknowledgement indication information to the intermediate network device by using the transmitter, where the routing rule acknowledgement indication information includes at least one of the following: identifiers of M routing rules acknowledged by the terminal in the K routing rules and identifiers of N rejected routing rules, where a sum of M and N is equal to K. This ensures consistency of routing rules used by a gateway device and the terminal, and ensures correct transmission of a traffic flow.

In one embodiment, before sending the NBIFOM routing rule request to the intermediate network device by using the transmitter, the processor is further configured to: in a process of establishing a PDN connection between the terminal and a gateway device, send a PDN connection establishment request to the gateway device through the intermediate network device by using the transmitter, where the PDN connection establishment request carries an NBIFOM mode indication, and the NBIFOM mode indication is used to indicate that a current NBIFOM mode is a network-initiated NBIFOM mode or a terminal-initiated NBIFOM mode, so that the intermediate network device records the current NBIFOM mode.

According to an eighth aspect, an embodiment of the present application provides an intermediate network device, including a communications interface, a processor, and a memory, where the memory is configured to store program code for performing a method for routing rule transmission; and the processor is configured to invoke the program code in the memory to perform: receiving, by using the communications interface, an NBIFOM routing rule request sent by a terminal, and sending the NBIFOM routing rule request to a gateway device by using the communications interface, where the NBIFOM routing rule request includes a routing rule generation parameter; receiving, by using the communications interface, K routing rules that are generated by the gateway device according to the NBIFOM routing rule request, and sending the K routing rules to the terminal by using the communications interface, where K is an integer greater than or equal to 1; and receiving, by using the communications interface, routing rule acknowledgement indication information sent by the terminal, and sending the routing rule acknowledgement indication information to the gateway device by using the communications interface, where the routing rule acknowledgement indication information includes at least one of the following: identifiers of M routing rules acknowledged by the terminal in the K routing rules and identifiers of N rejected routing rules, where a sum of M and N is equal to K. This ensures consistency of routing rules used by the gateway device and the terminal, and ensures correct transmission of a traffic flow.

In one embodiment, after receiving, by using the communications interface, the NBIFOM routing rule request sent by the terminal, the processor is further configured to send a routing rule timing instruction to the gateway device by using the communications interface; and after receiving, by using the communications interface, the K routing rules that are generated by the gateway device according to the routing rule request, the processor is further configured to send a routing rule reception response to the gateway device by using the communications interface; where the routing rule timing instruction is used to instruct the gateway device to: start timing when the gateway device receives the routing rule reception response, and determine an enforceable routing rule according to the routing rule acknowledgement indication information if the routing rule acknowledgement indication information is received before a timing time reaches the preset time, or determine the K routing rules as enforceable routing rules if the routing rule acknowledgement indication information is not received before a timing time reaches the preset time.

In one embodiment, before sending the K routing rules to the terminal by using the communications interface, the processor is further configured to determine that the NBIFOM routing rule request is sent by the terminal in a network-initiated NBIFOM mode.

In one embodiment, before receiving, by using the communications interface, the NBIFOM routing rule request sent by the terminal, the processor is further configured to: in a process of establishing a PDN connection between the terminal and the gateway device, receive, by using the communications interface, a PDN connection establishment request sent by the terminal to the gateway device, where the PDN connection establishment request includes an NBIFOM container, and the NBIFOM container carries an NBIFOM mode indication; or receive, by using the communications interface, a PDN connection establishment response sent by the gateway device to the terminal, where the PDN connection establishment response includes an NBIFOM container, and the NBIFOM container carries an NBIFOM mode indication; where the NBIFOM mode indication is used to indicate that a current NBIFOM mode is the network-initiated NBIFOM mode or a terminal-initiated NBIFOM mode; the processor is further configured to parse the NBIFOM container to obtain the NBIFOM mode indication, and record the current NBIFOM mode according to the NBIFOM mode indication; and when determining that the NBIFOM routing rule request is sent by the terminal in the network-initiated NBIFOM mode, the processor is specifically configured to determine, according to the current NBIFOM mode recorded as the network-initiated NBIFOM mode, that the NBIFOM routing rule request is sent by the terminal in the network-initiated NBIFOM mode.

In one embodiment, before receiving, by using the communications interface, the NBIFOM routing rule request sent by the terminal, the processor is further configured to: in a process of establishing a PDN connection between the terminal and the gateway device, receive, by using the communications interface, a PDN connection establishment request sent by the terminal to the gateway device, where the PDN connection establishment request carries an NBIFOM mode indication; or receive, by using the communications interface, a PDN connection establishment response sent by the gateway device to the terminal, where the PDN connection establishment response carries an NBIFOM mode indication; where the NBIFOM mode indication is used to indicate that a current NBIFOM mode is the network-initiated NBIFOM mode or a terminal-initiated NBIFOM mode; the processor is further configured to record the current NBIFOM mode according to the NBIFOM mode indication; and when determining that the NBIFOM routing rule request is sent by the terminal in the network-initiated NBIFOM mode, the processor is specifically configured to determine, according to the current NBIFOM mode recorded as the network-initiated NBIFOM mode, that the NBIFOM routing rule request is sent by the terminal in the network-initiated NBIFOM mode.

In one embodiment, the NBIFOM routing rule request further includes a first indication, and the first indication is used to indicate whether a current access network is available to the terminal, or used to indicate that a traffic flow of the terminal in the current corresponding access network needs to be transferred from an RAN to a WLAN or from a WLAN to an RAN, or used to indicate that a type of the NBIFOM routing rule request is a traffic flow mapping request; and when determining that the NBIFOM routing rule request is sent by the terminal in the network-initiated NBIFOM mode, the processor is specifically configured to determine, according to the first indication, that the NBIFOM routing rule request is sent by the terminal in the network-initiated NBIFOM mode.

According to a ninth aspect, an embodiment of the present application provides a gateway device, including a communications interface, a processor, and a memory, where the memory is configured to store program code for performing a method for routing rule transmission; and the processor is configured to invoke the program code in the memory to perform: receiving, by using the communications interface, an NBIFOM routing rule request sent by an intermediate network device, where the NBIFOM routing rule request includes a routing rule generation parameter; generating K routing rules according to the NBIFOM routing rule request, where K is an integer greater than or equal to 1; sending the K routing rules to the intermediate network device by using the communications interface; receiving, by using the communications interface, routing rule acknowledgement indication information sent by the intermediate network device, where the routing rule acknowledgement indication information includes at least one of the following: identifiers of M routing rules acknowledged by a terminal in the K routing rules and identifiers of N rejected routing rules, where a sum of M and N is equal to K; and determining, according to the routing rule acknowledgement indication information, the N routing rules rejected by the terminal in the K routing rules. This ensures consistency of routing rules used by the gateway device and the terminal, and ensures correct transmission of a traffic flow.

In one embodiment, after receiving, by using the communications interface, the NBIFOM routing rule request sent by the intermediate network device, the processor is further configured to receive, by using the communications interface, a routing rule timing instruction sent by the intermediate network device; after sending the K routing rules to the intermediate network device by using the communications interface, the processor is further configured to receive, by using the communications interface, a routing rule reception response sent by the intermediate network device; the processor is further configured to start timing according to the routing rule timing instruction when the routing rule reception response is received; and when receiving, by using the communications interface, the routing rule acknowledgement indication information sent by the intermediate network device, the processor is specifically configured to receive the routing rule acknowledgement indication information by using the communications interface before a timing time reaches a preset time.

In one embodiment, if determining that the routing rule acknowledgement indication information is not received by using the communications interface before the timing time reaches the preset time, the processor is further configured to determine that the K routing rules are enforceable routing rules.

In one embodiment, before receiving, by using the communications interface, the NBIFOM routing rule request sent by the intermediate network device, the processor is further configured to: in a process of establishing a PDN connection between the gateway device and the terminal, send a PDN connection establishment response to the terminal through the intermediate network device by using the communications interface, where the PDN connection establishment response carries an NBIFOM mode indication, and the NBIFOM mode indication is used to indicate that a current NBIFOM mode is a network-initiated NBIFOM mode or a terminal-initiated NBIFOM mode, so that the intermediate network device records the current NBIFOM mode.

According to a tenth aspect, an embodiment of the present application provides a system for routing rule transmission, where the system includes the terminal according to any one of the fourth aspect or the possible implementations of the fourth aspect, the intermediate network device according to any one of the fifth aspect or the possible implementations of the fifth aspect, and the gateway device according to any one of the sixth aspect or the possible implementations of the sixth aspect; or the terminal according to any one of the seventh aspect or the possible implementations of the seventh aspect, the intermediate network device according to any one of the eighth aspect or the possible implementations of the eighth aspect, and the gateway device according to any one of the ninth aspect or the possible implementations of the ninth aspect.

According to an eleventh aspect, an embodiment of the present application provides a method for routing rule transmission, where the method includes:

receiving, by an intermediate network device, an NBIFOM routing rule request sent by a terminal, and sending the NBIFOM routing rule request to a gateway device;

receiving, by the intermediate network device, an NBIFOM container including K routing rules and sent by the gateway device, and sending the NBIFOM container including the K routing rules to the terminal, where K is an integer greater than or equal to 1; and

receiving, by the intermediate network device, routing rule acknowledgement indication information sent by the terminal, and sending the routing rule acknowledgement indication information to the gateway device, where the routing rule acknowledgement indication information includes first indication information or second indication information, the first indication information is used to indicate that the terminal accepts the K routing rules, and the second indication information is used to indicate that the terminal rejects at least one of the K routing rules.

In one embodiment, after the receiving, by an intermediate network device, an NBIFOM routing rule request sent by a terminal, the method further includes:

determining, by the intermediate network device, whether third indication information is received from the gateway device, where the third indication information is used to instruct the intermediate network device to send an acknowledgement message that does not carry any routing rule to the terminal; and

if the intermediate network device determines that the third indication information is received from the gateway device, sending, by the intermediate network device, an acknowledgement message to the terminal, where the acknowledgement message does not carry the NBIFOM container including the K routing rules, and the acknowledgement message is used to acknowledge reception of the NBIFOM routing rule request sent by the terminal.

In one embodiment, the sending, by the intermediate network device, the NBIFOM container including the K routing rules to the terminal includes:

determining, by the intermediate network device, whether third indication information is received from the gateway device, where the third indication information is used to indicate that a feedback of the terminal is required for an NBIFOM container sent by the intermediate network device, or the third indication information is used to instruct the intermediate network device to send an NBIFOM container to the terminal by using a request message; and

if the intermediate network device determines that the third indication information is received from the gateway device, sending, by the intermediate network device, a first request message to the terminal, where the first request message carries the NBIFOM container including the K routing rules.

In one embodiment, the first request message is a request secondary PDP context activation message or a modify PDP context request message.

In one embodiment, the method further includes:

sending, by the intermediate network device, an acknowledgement message to the terminal, where the acknowledgement message does not carry the NBIFOM container including the K routing rules, and the acknowledgement message is used to acknowledge reception of the NBIFOM routing rule request sent by the terminal.

In one embodiment, the method further includes:

receiving, by the intermediate network device, the third indication information from the gateway device.

In one embodiment, the third indication information and the NBIFOM container including the K routing rules are both carried in a create bearer request message or an update bearer request message; or

the third indication information is carried in a create session response message, and the NBIFOM container including the K routing rules is carried in a create bearer request message or an update bearer request message.

In one embodiment, after the receiving, by the intermediate network device, the third indication information from the gateway device, the method further includes:

storing, by the intermediate network device, the third indication information.

In one embodiment, the NBIFOM routing rule request includes an NBIFOM container.

According to a twelfth aspect, an embodiment of the present application provides a method for routing rule transmission, where the method includes:

receiving, by a gateway device, an NBIFOM routing rule request; and

sending, by the gateway device according to the NBIFOM routing rule request, third indication information and an NBIFOM container including K routing rules to an intermediate network device; where

K is an integer greater than or equal to 1, and the third indication information is used to instruct the intermediate network device to send an acknowledgement message that does not carry any routing rule to a terminal, or the third indication information is used to indicate that a feedback of a terminal is required for an NBIFOM container sent by the intermediate network device, or the third indication information is used to instruct the intermediate network device to send an NBIFOM container to a terminal by using a request message.

In one embodiment, the sending, by the gateway device, third indication information to an intermediate network device includes:

if a packet data network PDN connection of the terminal is in a network-initiated NBIFOM mode, sending, by the gateway device, the third indication information to the intermediate network device.

In one embodiment, before the receiving, by a gateway device, an NBIFOM routing rule request, the method further includes:

receiving, by the gateway device, mode indication information sent by a policy and charging rules function (PCRF), where the mode indication information is used to indicate the mode of the PDN connection of the terminal; and

storing, by the gateway device, the mode indication information.

In one embodiment, the third indication information and the K routing rules are carried in a create bearer request message or an update bearer request message.

According to a thirteenth aspect, an embodiment of the present application provides a method for routing rule transmission, where the method includes:

receiving, by a gateway device, mode indication information sent by a PCRF, where the mode indication information is used to indicate a mode of a PDN connection of a terminal;

if the mode indication information indicates that the PDN connection of the terminal is in a network-initiated NBIFOM mode, sending, by the gateway device, third indication information to an intermediate network device, where the third indication information is used to instruct the intermediate network device to send an acknowledgement message that does not carry any routing rule to the terminal, or the third indication information is used to indicate that a feedback of the terminal is required for an NBIFOM container sent by the intermediate network device, or the third indication information is used to instruct the intermediate network device to send an NBIFOM container to the terminal by using a request message;

receiving, by the gateway device, an NBIFOM routing rule request; and

sending, by the gateway device according to the NBIFOM routing rule request, an NBIFOM container including K routing rules to the intermediate network device, where K is an integer greater than or equal to 1.

In one embodiment, the third indication information is carried in a create session response message and sent to the intermediate network device.

According to a fourteenth aspect, an embodiment of the present application provides an intermediate network device, including:

a receiving unit, configured to receive an NBIFOM routing rule request sent by a terminal; and

a sending unit, configured to send the NBIFOM routing rule request received by the receiving unit to a gateway device; where

the receiving unit is further configured to receive an NBIFOM container including K routing rules and sent by the gateway device, where K is an integer greater than or equal to 1;

the sending unit is further configured to send the NBIFOM container including the K routing rules and received by the receiving unit to the terminal;

the receiving unit is further configured to receive routing rule acknowledgement indication information sent by the terminal, where the routing rule acknowledgement indication information includes first indication information or second indication information, the first indication information is used to indicate that the terminal accepts the K routing rules, and the second indication information is used to indicate that the terminal rejects at least one of the K routing rules; and the sending unit is further configured to send the routing rule acknowledgement indication information received by the receiving unit to the gateway device.

In one embodiment, the intermediate network device further includes:

a determining unit, configured to determine, after the receiving unit receives the NBIFOM routing rule request sent by the terminal, whether third indication information is received from the gateway device, where the third indication information is used to instruct the intermediate network device to send an acknowledgement message that does not carry any routing rule to the terminal; where

if the determining unit determines that the third indication information is received from the gateway device, the sending unit is further configured to send an acknowledgement message to the terminal, where the acknowledgement message does not carry the NBIFOM container including the K routing rules, and the acknowledgement message is used to acknowledge reception of the NBIFOM routing rule request sent by the terminal.

In one embodiment, the intermediate network device further includes:

a determining unit, configured to determine whether third indication information is received from the gateway device, where the third indication information is used to indicate that a feedback of the terminal is required for an NBIFOM container sent by the intermediate network device, or the third indication information is used to instruct the intermediate network device to send an NBIFOM container to the terminal by using a request message; where

if the determining unit determines that the third indication information is received from the gateway device, the sending unit is further configured to send a first request message to the terminal, where the first request message carries the NBIFOM container including the K routing rules.

In one embodiment, the first request message is a request secondary PDP context activation message or a modify PDP context request message.

In one embodiment, the sending unit is further configured to send an acknowledgement message to the terminal, where the acknowledgement message does not carry the NBIFOM container including the K routing rules, and the acknowledgement message is used to acknowledge reception of the NBIFOM routing rule request sent by the terminal.

In one embodiment, the receiving unit is further configured to receive the third indication information from the gateway device.

Optionally, the third indication information and the NBIFOM container including the K routing rules are both carried in a create bearer request message or an update bearer request message; or

the third indication information is carried in a create session response message, and the NBIFOM container including the K routing rules is carried in a create bearer request message or an update bearer request message.

In one embodiment, the intermediate network device further includes a storage unit, configured to store, after the receiving unit receives the third indication information from the gateway device, the third indication information received by the receiving unit.

Optionally, the NBIFOM routing rule request includes an NBIFOM container.

According to a fifteenth aspect, an embodiment of the present application provides a gateway device, including:

a receiving unit, configured to receive an NBIFOM routing rule request; and

a sending unit, configured to send, according to the NBIFOM routing rule request received by the receiving unit, third indication information and an NBIFOM container including K routing rules to an intermediate network device; where

K is an integer greater than or equal to 1, and the third indication information is used to instruct the intermediate network device to send an acknowledgement message that does not carry any routing rule to a terminal, or the third indication information is used to indicate that a feedback of a terminal is required for an NBIFOM container sent by the intermediate network device, or the third indication information is used to instruct the intermediate network device to send an NBIFOM container to a terminal by using a request message.

In one embodiment, when sending the third indication information to the intermediate network device, the sending unit is specifically configured to send the third indication information to the intermediate network device if a packet data network PDN connection of the terminal is in a network-initiated NBIFOM mode.

In one embodiment, the gateway device further includes a storage unit, where

before receiving the NBIFOM routing rule request, the receiving unit is further configured to receive mode indication information sent by a PCRF, where the mode indication information is used to indicate the mode of the PDN connection of the terminal; and

the storage unit is configured to store the mode indication information received by the receiving unit.

In one embodiment, the third indication information and the K routing rules are carried in a create bearer request message or an update bearer request message.

According to a sixteenth aspect, an embodiment of the present application provides a gateway device, including:

a receiving unit, configured to receive mode indication information sent by a PCRF, where the mode indication information is used to indicate a mode of a packet data network PDN connection of a terminal; and

a sending unit, configured to send third indication information to an intermediate network device if the mode indication information received by the receiving unit indicates that the PDN connection of the terminal is in a network-initiated NBIFOM mode, where the third indication information is used to instruct the intermediate network device to send an acknowledgement message that does not carry any routing rule to the terminal, or the third indication information is used to indicate that a feedback of the terminal is required for an NBIFOM container sent by the intermediate network device, or the third indication information is used to instruct the intermediate network device to send an NBIFOM container to the terminal by using a request message; where

the receiving unit is further configured to receive an NBIFOM routing rule request; and

the sending unit is further configured to send, according to the NBIFOM routing rule request received by the receiving unit, an NBIFOM container including K routing rules to the intermediate network device, where K is an integer greater than or equal to 1.

In one embodiment, the third indication information is carried in a create session response message and sent to the intermediate network device.

According to a seventeenth aspect, an embodiment of the present application provides an intermediate network device, including a first communications interface, a second communications interface, a processor, and a memory, where

the memory is configured to store program code for performing a method for routing rule transmission; and

the processor is configured to invoke the program code in the memory to perform:

receiving, by using the first communications interface, an NBIFOM routing rule request sent by a terminal, and sending the NBIFOM routing rule request to a gateway device by using the second communications interface; receiving, by using the second communications interface, an NBIFOM container including K routing rules and sent by the gateway device, and sending, by using the first communications interface, the NBIFOM container including the K routing rules to the terminal, where K is an integer greater than or equal to 1; and receiving, by using the first communications interface, routing rule acknowledgement indication information sent by the terminal, and sending the routing rule acknowledgement indication information to the gateway device by using the second communications interface, where the routing rule acknowledgement indication information includes first indication information or second indication information, the first indication information is used to indicate that the terminal accepts the K routing rules, and the second indication information is used to indicate that the terminal rejects at least one of the K routing rules.

In one embodiment, after receiving, by using the first communications interface, the NBIFOM routing rule request sent by the terminal, the processor is further configured to: determine whether third indication information is received from the gateway device, where the third indication information is used to instruct the intermediate network device to send an acknowledgement message that does not carry any routing rule to the terminal; and if determining that the third indication information is received from the gateway device, send an acknowledgement message to the terminal by using the first communications interface, where the acknowledgement message does not carry the NBIFOM container including the K routing rules, and the acknowledgement message is used to acknowledge reception of the NBIFOM routing rule request sent by the terminal.

In one embodiment, the processor is further configured to determine whether third indication information is received from the gateway device, where the third indication information is used to indicate that a feedback of the terminal is required for an NBIFOM container sent by the intermediate network device, or the third indication information is used to instruct the intermediate network device to send an NBIFOM container to the terminal by using a request message; and

when sending, by using the first communications interface, the NBIFOM container including the K routing rules to the terminal, the processor is specifically configured to send a first request message to the terminal by using the first communications interface if determining that the third indication information is received from the gateway device, where the first request message carries the NBIFOM container including the K routing rules.

In one embodiment, the first request message is a request secondary packet data protocol PDP context activation message or a modify PDP context request message.

In one embodiment, the processor is further configured to send an acknowledgement message to the terminal by using the first communications interface, where the acknowledgement message does not carry the NBIFOM container including the K routing rules, and the acknowledgement message is used to acknowledge reception of the NBIFOM routing rule request sent by the terminal.

In one embodiment, the processor is further configured to receive the third indication information from the gateway device by using the second communications interface.

In one embodiment, the third indication information and the NBIFOM container including the K routing rules are both carried in a create bearer request message or an update bearer request message; or

the third indication information is carried in a create session response message, and the NBIFOM container including the K routing rules is carried in a create bearer request message or an update bearer request message.

In one embodiment, after receiving the third indication information from the gateway device by using the second communications interface, the processor is further configured to store the third indication information.

In one embodiment, the NBIFOM routing rule request includes an NBIFOM container.

According to an eighteenth aspect, an embodiment of the present application provides a gateway device, including a first communications interface, a processor, and a memory, where

the memory is configured to store program code for performing a method for routing rule transmission; and

the processor is configured to invoke the program code in the memory to perform:

receiving an NBIFOM routing rule request by using the first communications interface; and sending, according to the NBIFOM routing rule request, third indication information and an NBIFOM container including K routing rules to an intermediate network device by using the first communications interface; where K is an integer greater than or equal to 1,

and the third indication information is used to instruct the intermediate network device to send an acknowledgement message that does not carry any routing rule to the terminal, or the third indication information is used to indicate that a feedback of the terminal is required for an NBIFOM container sent by the intermediate network device, or the third indication information is used to instruct the intermediate network device to send an NBIFOM container to the terminal by using a request message.

In one embodiment, when sending the third indication information to the intermediate network device by using the first communications interface, the processor is specifically configured to send the third indication information to the intermediate network device by using the first communications interface if a PDN connection of the terminal is in a network-initiated NBIFOM mode.

In one embodiment, the gateway device further includes a second communications interface, where

before receiving the NBIFOM routing rule request by using the first communications interface, the processor is further configured to: receive, by using the second communications interface, mode indication information sent by a PCRF, where the mode indication information is used to indicate the mode of the PDN connection of the terminal; and store the mode indication information.

In one embodiment, the third indication information and the K routing rules are carried in a create bearer request message or an update bearer request message.

According to a nineteenth aspect, an embodiment of the present application provides a gateway device, including a first communications interface, a second communications interface, a processor, and a memory, where

the memory is configured to store program code for performing a method for routing rule transmission; and

the processor is configured to invoke the program code in the memory to perform:

receiving, by using the first communications interface, mode indication information sent by a PCRF, where the mode indication information is used to indicate a mode of a PDN connection of a terminal; if the mode indication information indicates that the PDN connection of the terminal is in a network-initiated NBIFOM mode, sending third indication information to an intermediate network device by using the second communications interface, where the third indication information is used to instruct the intermediate network device to send an acknowledgement message that does not carry any routing rule to the terminal, or the third indication information is used to indicate that a feedback of the terminal is required for an NBIFOM container sent by the intermediate network device, or the third indication information is used to instruct the intermediate network device to send an NBIFOM container to the terminal by using a request message; receiving an NBIFOM routing rule request by using the second communications interface; and sending, according to the NBIFOM routing rule request, an NBIFOM container including K routing rules to the intermediate network device by using the second communications interface, where K is an integer greater than or equal to 1.

In one embodiment, the third indication information is carried in a create session response message and sent to the intermediate network device.

In the foregoing solutions of the embodiments of the present application, the terminal sends the NBIFOM routing rule request to the gateway device through the intermediate network device; the gateway device sends at least one routing rule to the terminal through the intermediate network device according to the NBIFOM routing rule request; the terminal sends the routing rule acknowledgement indication information to the gateway device through the intermediate network device according to the at least one received routing rule; and the gateway device determines, according to the routing rule acknowledgement indication information, a routing rule rejected by the terminal in the at least one routing rule, so that the gateway device transmits a traffic flow by using a routing rule other than the routing rule rejected by the terminal in the at least one routing rule. This ensures consistency of routing rules used by the gateway device and the terminal, and ensures correct transmission of the traffic flow.

### BRIEF DESCRIPTION OF DRAWINGS

To describe the technical solutions in the embodiments of the present application more clearly, the following briefly describes the accompanying drawings required for describing the embodiments. Apparently, the accompanying drawings in the following description show some embodiments of the present application, and persons of ordinary skill in the art may still derive other drawings from these accompanying drawings without creative efforts.

FIG. 1 is an architectural diagram of a network to which a method for routing rule transmission according to an embodiment of the present application is applied;

FIG. 2 is a flowchart of a method for routing rule transmission according to Embodiment 1 of the present application;

FIG. 3 is a flowchart of a method for routing rule transmission according to Embodiment 2 of the present application;

FIG. 4 is a flowchart of a method for routing rule transmission according to Embodiment 4 of the present application;

FIG. 5 is a flowchart of a method for routing rule transmission according to Embodiment 5 of the present application;

FIG. 6 is a schematic structural diagram of a terminal according to Embodiment 1 of the present application;

FIG. 7 is a schematic structural diagram of an intermediate network device according to Embodiment 1 of the present application;

FIG. 8 is a schematic structural diagram of a gateway device according to Embodiment 1 of the present application;

FIG. 9 is a schematic structural diagram of a terminal according to Embodiment 2 of the present application;

FIG. 10 is a schematic structural diagram of an intermediate network device according to Embodiment 2 of the present application;

FIG. 11 is a schematic structural diagram of a gateway device according to Embodiment 2 of the present application;

FIG. 12 is a schematic structural diagram of a system for routing rule transmission according to Embodiment 1 of the present application;

FIG. 13 is a flowchart of a method for routing rule transmission according to Embodiment 6 of the present application;

FIG. 14 is a flowchart of a method for routing rule transmission according to Embodiment 7 of the present application;

FIG. 15 is a flowchart of a method for routing rule transmission according to Embodiment 8 of the present application;

FIG. 16A and FIG. 16B are a flowchart of a method for routing rule transmission according to Embodiment 9 of the present application;

FIG. 17A and FIG. 17B are a flowchart of a method for routing rule transmission according to Embodiment 10 of the present application;

FIG. 18 is a schematic structural diagram of an intermediate network device according to Embodiment 3 of the present application;

FIG. 19 is a schematic structural diagram of a gateway device according to Embodiment 3 of the present application;

FIG. 20 is a schematic structural diagram of a gateway device according to Embodiment 4 of the present application;

FIG. 21 is a schematic structural diagram of an intermediate network device according to Embodiment 4 of the present application;

FIG. 22 is a schematic structural diagram of a gateway device according to Embodiment 5 of the present application;

FIG. 23 is a schematic structural diagram of a gateway device according to Embodiment 6 of the present application; and

FIG. 24 is a schematic structural diagram of a system for routing rule transmission according to Embodiment 2 of the present application.

### DESCRIPTION OF EMBODIMENTS

To make the objectives, technical solutions, and advantages of the embodiments of the present application clearer, the following clearly describes the technical solutions in the embodiments of the present application with reference to the accompanying drawings in the embodiments of the present application. Apparently, the described embodiments are some but not all of the embodiments of the present application. All other embodiments obtained by persons of ordinary skill in the art based on the embodiments of the present application without creative efforts shall fall within the protection scope of the present application.

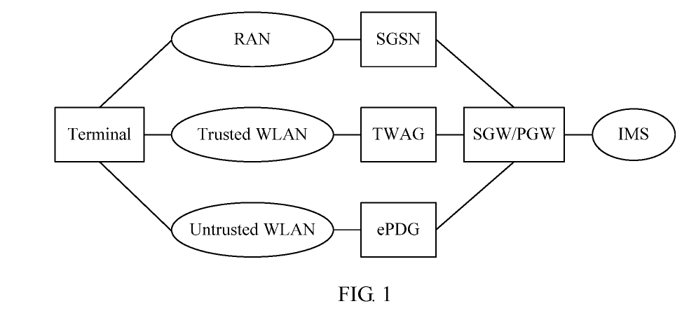

FIG. 1 is an architectural diagram of a network to which a method for routing rule transmission according to an embodiment of the present application is applied. As shown in FIG. 1, a terminal may access a same SGW or PGW through a 3GPP network and a non-3GPP network, and implement communication between the terminal and an IP multimedia subsystem (IMS). This feature is also referred to as NBIFOM. When accessing the serving gateway (SGW)/PGW through the 3GPP network, the terminal may access the SGW or the PGW by connecting to an SGSN through an RAN. When accessing the SGW or the PGW through the non-3GPP network, the terminal may access the SGW or the PGW by connecting to a trusted WLAN access gateway (TWAG) through a trusted WLAN, or access the SGW or the PGW by connecting to an evolved packet data gateway (ePDG) through an untrusted WLAN. The following embodiments of the present application may be implemented based on the network architecture shown in FIG. 1.

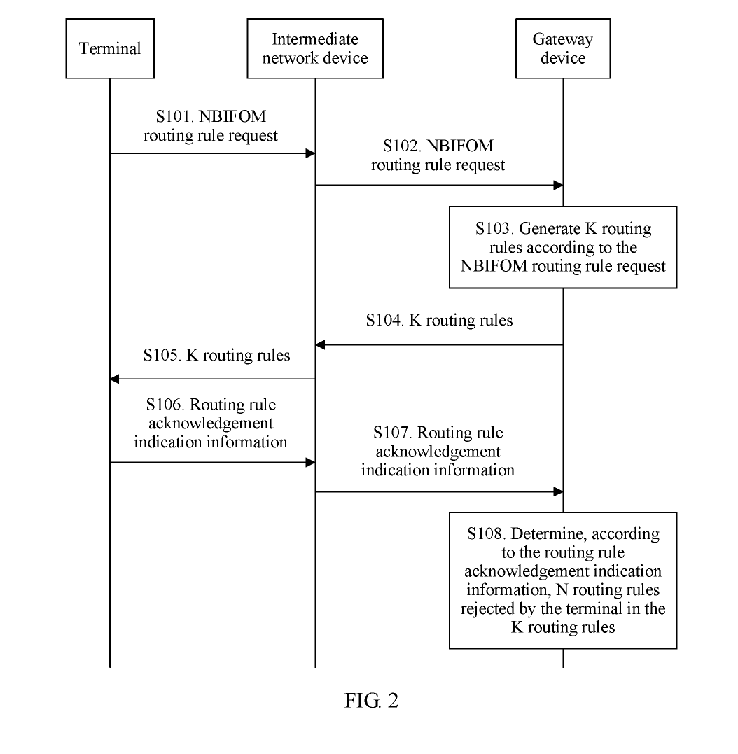

FIG. 2 is a flowchart of a method for routing rule transmission according to Embodiment 1 of the present application. As shown in FIG. 2, the method in this embodiment may include the following operations.

Operation S101. A terminal sends an NBIFOM routing rule request to an intermediate network device.

The method for routing rule transmission in this embodiment is applied to a network-initiated NBIFOM mode, and the network-initiated NBIFOM mode indicates that a routing rule for a traffic flow is determined by a network. When the terminal needs to request a routing rule for a traffic flow, the routing rule for the traffic flow may include at least one of the following: a routing rule for a modified traffic flow or a routing rule for a new traffic flow. The terminal sends the NBIFOM routing rule request to the intermediate network device. The NBIFOM routing rule request includes a routing rule generation parameter. The specific routing rule generation parameter is similar to a parameter carried when a terminal requests a routing rule in the prior art. Details are not further described herein.

Operation S102. The intermediate network device sends the NBIFOM routing rule request to a gateway device.

In this embodiment, the intermediate network device receives the NBIFOM routing rule request sent by the terminal, and sends the NBIFOM routing rule request to the gateway device.

Operation S103. The gateway device generates K routing rules according to the NBIFOM routing rule request.

In this embodiment, the gateway device receives the NBIFOM routing rule request sent by the intermediate network device, and generates the K routing rules according to the routing rule generation parameter in the NBIFOM routing rule request, where K is an integer greater than or equal to 1.

Operation S104. The gateway device sends the K routing rules to the intermediate network device.

In this embodiment, after generating the K routing rules, the gateway device sends the K routing rules to the intermediate network device.

Operation S105. The intermediate network device sends the K routing rules to the terminal.

In this embodiment, the intermediate network device receives the K routing rules that are generated by the gateway device according to the NBIFOM routing rule request, and sends the K routing rules to the terminal. Each routing rule includes the following parameters: a routing filter, routing access information, a routing rule priority, and a routing rule identifier. The routing filter includes an IP packet header parameter used to identify a traffic flow or a data packet corresponding to the routing rule. The routing access information is used to identify an access network that transmits the traffic flow. The routing rule priority is used to identify a sequence of routing rule matching.

The routing rule identifier is unique in a PDN connection.

Operation S106. The terminal sends routing rule acknowledgement indication information to the intermediate network device.

In this embodiment, the terminal receives the K routing rules sent by the intermediate network device, and may learn that the K routing rules are routing rules generated by the network. Then the terminal may determine whether any routing rule encounters an error in a transmission process or determine, based on a status of a current access network, whether the routing rules can be enforced, and therefore determine that a routing rule encountering an error in the transmission process or a routing rule that cannot be enforced based on the status of the current access network is a routing rule that needs to be rejected by the terminal in the K routing rules. Then the terminal sends the routing rule acknowledgement indication information to the intermediate network device, where the routing rule acknowledgement indication information includes at least one of the following: identifiers of M routing rules acknowledged by the terminal in the K routing rules and identifiers of N rejected routing rules, where a sum of M and N is equal to K.

Operation S107. The intermediate network device sends the routing rule acknowledgement indication information to the gateway device.

In this embodiment, the intermediate network device receives the routing rule acknowledgement indication information sent by the terminal, and sends the routing rule acknowledgement indication information to the gateway device.

Operation S108. The gateway device determines, according to the routing rule acknowledgement indication information, N routing rules rejected by the terminal in the K routing rules.

In this embodiment, the gateway device receives the routing rule acknowledgement indication information sent by the intermediate network device, and determines, according to the routing rule acknowledgement indication information, the N routing rules rejected by the terminal in the K routing rules. Then the gateway device does not use the N routing rules rejected by the terminal to transmit the traffic flow, but uses the M routing rules acknowledged by the terminal to transmit the traffic flow. This ensures consistency of routing rules used by the gateway device and the terminal, and ensures correct transmission of the traffic flow.

When the routing rule acknowledgement indication information includes the identifiers of the M routing rules acknowledged by the terminal in the K routing rules, the gateway device may determine, according to the identifiers of the M routing rules, that identifiers of (K-M) routing rules other than the identifiers of the M routing rules in the identifiers of the K routing rules are identifiers of the routing rules rejected by the terminal, that is, the N routing rules are the routing rules rejected by the terminal.

When the routing rule acknowledgement indication information includes the identifiers of the N routing rules rejected by the terminal in the K routing rules, the gateway device may determine, according to the identifiers of the N routing rules, that the identifiers of the N routing rules in the identifiers of the K routing rules are identifiers of the routing rules rejected by the terminal, that is, the N routing rules are the routing rules rejected by the terminal.

When the routing rule acknowledgement indication information includes the identifiers of the M routing rules acknowledged by the terminal in the K routing rules and the identifiers of the N routing rules rejected by the terminal in the K routing rules, the gateway device may determine, according to the identifiers of the N routing rules, that the identifiers of the N routing rules in the identifiers of the K routing rules are identifiers of the routing rules rejected by the terminal, that is, the N routing rules are the routing rules rejected by the terminal.

In this embodiment, the terminal sends the NBIFOM routing rule request to the gateway device through the intermediate network device; the gateway device generates at least one routing rule according to the NBIFOM routing rule request, and sends the at least one routing rule to the terminal through the intermediate network device; the terminal sends the routing rule acknowledgement indication information to the gateway device through the intermediate network device according to the at least one received routing rule; and the gateway device determines, according to the routing rule acknowledgement indication information, a routing rule rejected by the terminal in the at least one routing rule, so that the gateway device transmits the traffic flow by using a routing rule other than the routing rule rejected by the terminal in the at least one routing rule. This ensures consistency of routing rules used by the gateway device and the terminal, and ensures correct transmission of the traffic flow.

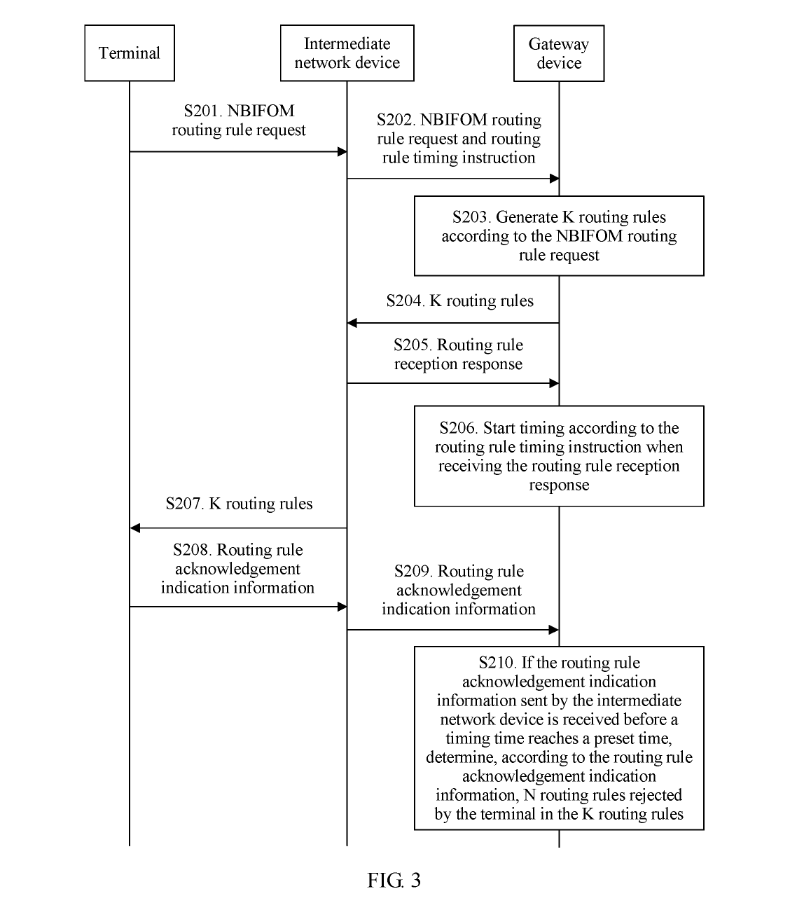

FIG. 3 is a flowchart of a method for routing rule transmission according to Embodiment 2 of the present application. As shown in FIG. 3, the method in this embodiment may include the following operations.

Operation S201. A terminal sends an NBIFOM routing rule request to an intermediate network device.

In this embodiment, for a specific implementation process of S201, refer to related descriptions in method Embodiment 1 of the present application. Details are not further described herein.

Operation S202. The intermediate network device sends the NBIFOM routing rule request and a routing rule timing instruction to a gateway device.

In this embodiment, after receiving the NBIFOM routing rule request sent by the terminal, the intermediate network device sends the NBIFOM routing rule request to the gateway device, and further sends the routing rule timing instruction to the gateway device. It should be noted that, the intermediate network device may send the NBIFOM routing rule request and the routing rule timing instruction to the gateway device in a same step or in different steps. This is not limited in this embodiment. In addition, in this embodiment, the intermediate network device may send the routing rule timing instruction to the gateway device before S205.

The routing rule timing instruction in this embodiment is used to instruct the gateway device to: start timing when the gateway device receives a routing rule reception response, and determine an enforceable routing rule according to routing rule acknowledgement indication information if the routing rule acknowledgement indication information is received before a timing time reaches a preset time, or determine K routing rules as enforceable routing rules if the routing rule acknowledgement indication information is not received before a timing time reaches a preset time.

Operation S203. The gateway device generates K routing rules according to the NBIFOM routing rule request.

Operation S204. The gateway device sends the K routing rules to the intermediate network device.

In this embodiment, for specific implementation processes of S203 and S204, refer to related descriptions in method Embodiment 1 of the present application. Details are not further described herein.

Operation S205. The intermediate network device sends a routing rule reception response to the gateway device.

Operation S206. The gateway device starts timing according to the routing rule timing instruction when receiving the routing rule reception response.

In this embodiment, after receiving the K routing rules sent by the gateway device, the intermediate network device sends the routing rule reception response to the gateway device. The gateway device receives the routing rule reception response sent by the intermediate network device, and starts timing according to the routing rule timing instruction when receiving the routing rule reception response.

Operation S207. The intermediate network device sends the K routing rules to the terminal.

In this embodiment, after sending the routing rule reception response to the gateway device, the intermediate network device sends the K routing rules to the terminal. It should be noted that, an execution sequence of S205 and S207 is not limited.

Operation S208. The terminal sends routing rule acknowledgement indication information to the intermediate network device.

In this embodiment, for a specific implementation process of S208, refer to related descriptions of S106 in method Embodiment 1 of the present application. Details are not further described herein.

Operation S209. The intermediate network device sends the routing rule acknowledgement indication information to the gateway device.

Operation S210. If the gateway device receives, before a timing time reaches a preset time, the routing rule acknowledgement indication information sent by the intermediate network device, the gateway device determines, according to the routing rule acknowledgement indication information, N routing rules rejected by the terminal in the K routing rules.

In this embodiment, after receiving the routing rule acknowledgement indication information sent by the terminal, the intermediate network device sends the routing rule acknowledgement indication information to the gateway device. In this embodiment, if the gateway device receives, before the timing time reaches the preset time, the routing rule acknowledgement indication information sent by the intermediate network device, that is, the timing time of the gateway device is less than the preset time, the gateway device determines, according to the routing rule acknowledgement indication information, the N routing rules rejected by the terminal in the K routing rules. Then the gateway device does not use the N routing rules rejected by the terminal to transmit a traffic flow, but uses M routing rules acknowledged by the terminal to transmit the traffic flow. This ensures consistency of routing rules used by the gateway device and the terminal, and ensures correct transmission of the traffic flow.

Optionally, in another embodiment, the foregoing S210 is not performed after S209 is performed. The intermediate network device sends the routing rule acknowledgement indication information to the gateway device after receiving the routing rule acknowledgement indication information sent by the terminal. If the gateway device does not receive, before the timing time reaches the preset time, the routing rule acknowledgement indication information sent by the intermediate network device, the gateway device determines that the K routing rules as enforceable routing rules. There are two possibilities: The gateway device has not received, after the timing time reaches the preset time, the routing rule acknowledgement indication information sent by the intermediate network device; and the gateway device receives, after the timing time reaches the preset time, the routing rule acknowledgement indication information sent by the intermediate network device. Then the gateway device transmits the traffic flow by using the K routing rules.

In this embodiment, the terminal sends the NBIFOM routing rule request to the gateway device through the intermediate network device, and the intermediate network device further sends the routing rule timing instruction to the gateway device; the gateway device generates at least one routing rule according to the NBIFOM routing rule request, and sends the at least one routing rule to the terminal through the intermediate network device; in addition, the intermediate network device sends the routing rule reception response to the gateway device; then the gateway device starts timing according to the routing rule timing instruction when receiving the routing rule reception response; and if the gateway device receives, before the timing time reaches the preset time, the routing rule acknowledgement indication information sent by the terminal through the intermediate network device, the gateway device determines, according to the routing rule acknowledgement indication information, a routing rule rejected by the terminal in the at least one routing rule, so that the gateway device transmits the traffic flow by using a routing rule other than the routing rule rejected by the terminal in the at least one routing rule. This ensures consistency of routing rules used by the gateway device and the terminal, and ensures correct transmission of the traffic flow.

A method for routing rule transmission according to Embodiment 3 of the present application is based on the method Embodiment 1 or 2 of the present application. In this embodiment, before sending the K routing rules to the terminal, the intermediate network device further determines that the NBIFOM routing rule request is sent by the terminal in the network-initiated NBIFOM mode. Optionally, on a basis of the method Embodiment 1 of the present application, the intermediate network device may determine, after receiving the NBIFOM routing rule request sent by the terminal, that the NBIFOM routing rule request is sent by the terminal in the network-initiated NBIFOM mode. Optionally, on a basis of the method Embodiment 2 of the present application, that the intermediate network device in this embodiment determines that the NBIFOM routing rule request is sent by the terminal in the network-initiated NBIFOM mode may be performed before the intermediate network device sends the routing rule timing instruction to the gateway device.

That the intermediate network device determines that the NBIFOM routing rule request is sent by the terminal in the network-initiated NBIFOM mode may include the following five feasible implementations.

In one embodiment, before the intermediate network device receives the NBIFOM routing rule request sent by the terminal, in a process of establishing a PDN connection between the terminal and the gateway device, the terminal sends a PDN connection establishment request to the gateway device through the intermediate network device. The intermediate network device may receive the PDN connection establishment request sent by the terminal to the gateway device. The PDN connection establishment request includes an NBIFOM container, the NBIFOM container carries an NBIFOM mode indication, and the NBIFOM mode indication is used to indicate that a current NBIFOM mode is the network-initiated NBIFOM mode or a terminal-initiated NBIFOM mode. Then the intermediate network device parses the NBIFOM container in the PDN connection establishment request to obtain the NBIFOM mode indication, and records the current NBIFOM mode according to the NBIFOM mode indication, that is, if the NBIFOM mode indication indicates that the current NBIFOM mode is the network-initiated NBIFOM mode, records the current NBIFOM mode as the network-initiated NBIFOM mode, or if the NBIFOM mode indication indicates that the current NBIFOM mode is the terminal-initiated NBIFOM mode, records the current NBIFOM mode as the terminal-initiated NBIFOM mode. Therefore, the intermediate network device may determine, according to the current NBIFOM mode recorded as the network-initiated NBIFOM mode, that the NBIFOM routing rule request is sent by the terminal in the network-initiated NBIFOM mode.

In another embodiment, before the intermediate network device receives the NBIFOM routing rule request sent by the terminal, in a process of establishing a PDN connection between the terminal and the gateway device, the terminal sends a PDN connection establishment request to the gateway device through the intermediate network device. The intermediate network device may receive the PDN connection establishment request sent by the terminal to the gateway device. The PDN connection establishment request carries an NBIFOM mode indication, the NBIFOM mode indication is used to indicate that a current NBIFOM mode is the network-initiated NBIFOM mode or a terminal-initiated NBIFOM mode. Then the intermediate network device records the current NBIFOM mode according to the NBIFOM mode indication in the PDN connection establishment request, that is, if the NBIFOM mode indication indicates that the current NBIFOM mode is the network-initiated NBIFOM mode, records the current NBIFOM mode as the network-initiated NBIFOM mode, or if the NBIFOM mode indication indicates that the current NBIFOM mode is the terminal-initiated NBIFOM mode, records the current NBIFOM mode as the terminal-initiated NBIFOM mode. Therefore, the intermediate network device may determine, according to the current NBIFOM mode recorded as the network-initiated NBIFOM mode, that the NBIFOM routing rule request is sent by the terminal in the network-initiated NBIFOM mode.

Optionally, on a basis of the first feasible implementation or the second feasible implementation, if the terminal establishes the PDN connection to the gateway device through an RAN, the intermediate network device is an SGSN, and the PDN connection establishment request is an activate PDN context request message. If the terminal establishes the PDN connection to the gateway device through a trusted WLAN, the intermediate network device is a TWAG, and the PDN connection establishment request is a WLCP PDN connection establishment request message. If the terminal establishes the PDN connection to the gateway device through an untrusted WLAN, the intermediate network device is an ePDG, and the PDN connection establishment request is an IKEv2 AUTH request message.

In another embodiment, before the intermediate network device receives the NBIFOM routing rule request sent by the terminal, in a process of establishing a PDN connection between the terminal and the gateway device, the gateway device sends a PDN connection establishment response to the terminal through the intermediate network device. The intermediate network device may receive the PDN connection establishment response sent by the gateway device to the terminal. The PDN connection establishment response includes an NBIFOM container, the NBIFOM container carries an NBIFOM mode indication, and the NBIFOM mode indication is used to indicate that a current NBIFOM mode is the network-initiated NBIFOM mode or a terminal-initiated NBIFOM mode. Then the intermediate network device parses the NBIFOM container in the PDN connection establishment response to obtain the NBIFOM mode indication, and records the current NBIFOM mode according to the NBIFOM mode indication, that is, if the NBIFOM mode indication indicates that the current NBIFOM mode is the network-initiated NBIFOM mode, records the current NBIFOM mode as the network-initiated NBIFOM mode, or if the NBIFOM mode indication indicates that the current NBIFOM mode is the terminal-initiated NBIFOM mode, records the current NBIFOM mode as the terminal-initiated NBIFOM mode. Therefore, the intermediate network device may determine, according to the current NBIFOM mode recorded as the network-initiated NBIFOM mode, that the NBIFOM routing rule request is sent by the terminal in the network-initiated NBIFOM mode.

In another embodiment, before the intermediate network device receives the NBIFOM routing rule request sent by the terminal, in a process of establishing a PDN connection between the terminal and the gateway device, the gateway device sends a PDN connection establishment response to the terminal through the intermediate network device. The intermediate network device may receive the PDN connection establishment response sent by the gateway device to the terminal. The PDN connection establishment response carries an NBIFOM mode indication, the NBIFOM mode indication is used to indicate that a current NBIFOM mode is the network-initiated NBIFOM mode or a terminal-initiated NBIFOM mode. Then the intermediate network device records the current NBIFOM mode according to the NBIFOM mode indication in the PDN connection establishment response, that is, if the NBIFOM mode indication indicates that the current NBIFOM mode is the network-initiated NBIFOM mode, records the current NBIFOM mode as the network-initiated NBIFOM mode, or if the NBIFOM mode indication indicates that the current NBIFOM mode is the terminal-initiated NBIFOM mode, records the current NBIFOM mode as the terminal-initiated NBIFOM mode. Therefore, the intermediate network device may determine, according to the current NBIFOM mode recorded as the network-initiated NBIFOM mode, that the NBIFOM routing rule request is sent by the terminal in the network-initiated NBIFOM mode.

Optionally, on a basis of the third feasible implementation or the fourth feasible implementation, the PDN connection establishment response is a create session response message. If the terminal establishes the PDN connection to the gateway device through an RAN, the intermediate network device is an SGSN. If the terminal establishes the PDN connection to the gateway device through a trusted WLAN, the intermediate network device is a TWAG If the terminal establishes the PDN connection to the gateway device through an untrusted WLAN, the intermediate network device is an ePDG

In another embodiment, the NBIFOM routing rule request further includes a first indication, where the first indication is used to indicate whether the current access network is available to the terminal, or used to indicate that the traffic flow of the terminal in the current corresponding access network needs to be transferred from an RAN to a WLAN or from a WLAN to an RAN, or used to indicate that a type of the NBIFOM routing rule request is a traffic flow mapping request. Therefore, the intermediate network device may determine, according to the first indication included in the NBIFOM routing rule request, that the NBIFOM routing rule request is sent by the terminal in the network-initiated NBIFOM mode. The WLAN may be a trusted WLAN or may be an untrusted WLAN.

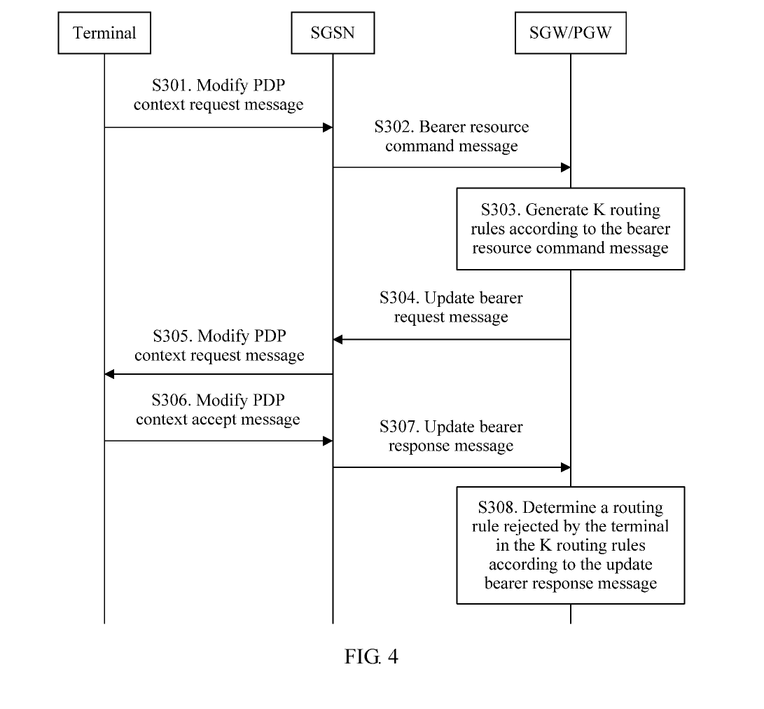

FIG. 4 is a flowchart of a method for routing rule transmission according to Embodiment 4 of the present application. As shown in FIG. 4, in this embodiment, for example, a terminal sends an NBIFOM routing rule request to a gateway device through an RAN, the gateway device is an SGW or a PGW, and correspondingly, an intermediate network device is an SGSN. The method in this embodiment may include the following operations.

Operation S301. A terminal sends a modify PDP context request message to an SGSN.

In this embodiment, the terminal sends an NBIFOM routing rule request to the SGSN by using the modify PDP context request message.

Operation S302. The SGSN sends a bearer resource command message to an SGW or a PGW.

In this embodiment, the SGSN receives the modify PDP context request message that carries the NBIFOM routing rule request and is sent by the terminal, and sends the NBIFOM routing rule request to the SGW or the PGW by using the bearer resource command message.

Operation S303. The SGW or the PGW generates K routing rules according to the bearer resource command message.

In this embodiment, after receiving the bearer resource command message, the SGW or the PGW generates the K routing rules according to the NBIFOM routing rule request in the bearer resource command message.

Operation S304. The SGW or the PGW sends an update bearer request message to the SGSN.

In this embodiment, after generating the K routing rules, the SGW or the PGW sends the K routing rules to the SGSN by using the update bearer request message.

Operation S305. The SGSN sends a modify PDP context request message to the terminal.

In this embodiment, after the SGSN obtains, by using the update bearer request message sent by the SGW or the PGW, the K routing rules generated by the SGW or the PGW, the SGSN sends the K routing rules to the terminal by using the modify PDP context request message.

Operation S306. The terminal sends a modify PDP context accept message to the SGSN.

In this embodiment, after the terminal obtains, by using the modify PDP context request message sent by the SGSN, the K routing rules generated by the SGW or the PGW, the terminal sends routing rule acknowledgement indication information to the SGSN by using the modify PDP context accept message. Optionally, if the routing rule acknowledgement indication information is used to indicate identifiers of the K routing rules rejected by the terminal, the terminal may send the routing rule acknowledgement indication information to the SGSN by using a modify PDP context reject message.

Operation S307. The SGSN sends an update bearer response message to the SGW or the PGW.

In this embodiment, the SGSN obtains the routing rule acknowledgement indication information by using the modify PDP context accept message sent by the terminal, and then sends the routing rule acknowledgement indication information to the SGW or the PGW by using the update bearer response message.

Operation S308. The SGW or the PGW determines a routing rule rejected by the terminal in the K routing rules according to the update bearer response message.

In this embodiment, the SGW or the PGW receives the update bearer response message sent by the SGSN, obtains the routing rule acknowledgement indication information in the update bearer response message, and may determine, according to the routing rule acknowledgement indication information, the routing rule rejected by the terminal in the K routing rules. Then the gateway device does not use N routing rules rejected by the terminal to transmit a traffic flow, but uses M routing rules acknowledged by the terminal to transmit the traffic flow. This ensures consistency of routing rules used by the gateway device and the terminal, and ensures correct transmission of the traffic flow.

Optionally, after the SGSN performs S302 and before the SGW or the PGW performs S304, the method further includes: S3021. The SGSN sends a modify PDP context accept message (not shown in the figure) to the terminal. In S3021, the modify PDP context accept message sent by the SGSN differs from the modify PDP context accept message in S306 in that the modify PDP context accept message in S3021 does not carry any routing rule. This is because the terminal starts a timer when sending the modify PDP context request message in S301 and stops timing when receiving a modify PDP context accept message. In S3021, the SGSN sends the modify PDP context accept message to the terminal so that the terminal stops timing when the terminal receives the modify PDP context accept message. Optionally, on this basis, before performing S3021, the intermediate network device determines that the modify PDP context request message carrying the NBIFOM routing rule request is sent by the terminal in a network-initiated NBIFOM mode.

On a basis of the method for routing rule transmission as shown in Embodiment 4 of the present application, optionally, the terminal sends the NBIFOM routing rule request to the gateway device through a trusted WLAN, the gateway device is the SGW or the PGW. Correspondingly, the SGSN in the foregoing method embodiment 4 is a TWAG, the modify PDP context request message is a WLCP PDN connection modification request message, the modify PDP context accept message is a WLCP PDN connection modification response message, and the modify PDP context reject message is a WLCP PDN connection modification reject message, where WLCP stands for the WLAN Control Protocol.

On a basis of the method for routing rule transmission as shown in Embodiment 4 of the present application, optionally, the terminal sends the NBIFOM routing rule request to the gateway device through an untrusted WLAN, the gateway device is the SGW or the PGW. Correspondingly, the SGSN in the foregoing method Embodiment 4 is an ePDG, the modify PDP context request message is an IKEv2 informational request message, and the modify PDP context accept message is an IKEv2 informational response.

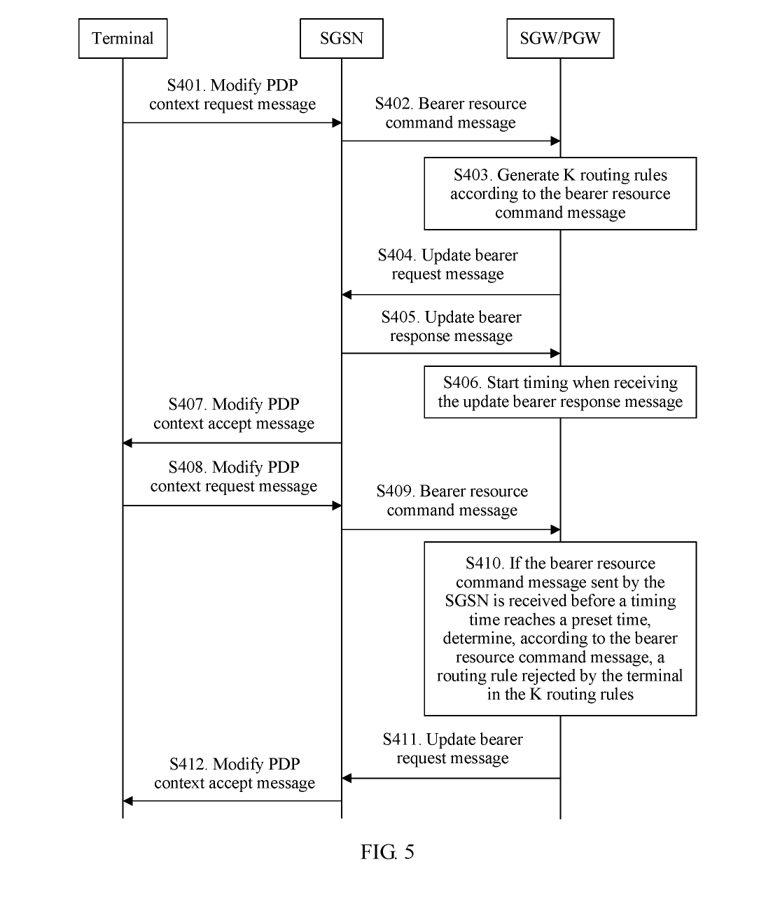

FIG. 5 is a flowchart of a method for routing rule transmission according to Embodiment 5 of the present application. As shown in FIG. 5, in this embodiment, for example, a terminal sends an NBIFOM routing rule request to a gateway device through an RAN, the gateway device is an SGW or a PGW, and correspondingly, an intermediate network device is an SGSN. The method in this embodiment may include the following operations.

Operation S401. A terminal sends a modify PDP context request message to an SGSN.

In this embodiment, the terminal sends an NBIFOM routing rule request to the SGSN by using the modify PDP context request message.

Operation S402. The SGSN sends a bearer resource command message to an SGW or a PGW.

In this embodiment, the SGSN receives the modify PDP context request message that carries the NBIFOM routing rule request and is sent by the terminal, and sends the NBIFOM routing rule request and a routing rule timing instruction to the SGW or the PGW by using the bearer resource command message.

The routing rule timing instruction is used to instruct the SGW or the PGW to: start timing when the SGW or the PGW receives an update bearer response message carrying a routing rule reception response, and determine an enforceable routing rule according to a modify PDP context request message if the modify PDP context request message carrying routing rule acknowledgement indication information is received before a timing time reaches a preset time, or determine K routing rules as enforceable routing rules if the modify PDP context request message carrying routing rule acknowledgement indication information is not received before a timing time reaches a preset time.

Optionally, before performing S402, the intermediate network device determines that the modify PDP context request message carrying the NBIFOM routing rule request is sent by the terminal in a network-initiated NBIFOM mode.

Operation S403. The SGW or the PGW generates K routing rules according to the bearer resource command message.

In this embodiment, after receiving the bearer resource command message, the SGW or the PGW generates the K routing rules according to the NBIFOM routing rule request in the bearer resource command message.

Operation S404. The SGW or the PGW sends an update bearer request message to the SGSN.

In this embodiment, after generating the K routing rules, the SGW or the PGW sends the K routing rules to the SGSN by using the update bearer request message.

Operation S405. The SGSN sends an update bearer response message to the SGW or the PGW.

In this embodiment, after the SGSN obtains, by using the update bearer request message sent by the SGW or the PGW, the K routing rules generated by the SGW or the PGW, the SGSN sends the routing rule reception response to the SGW or the PGW by using the update bearer response message.

Operation S406. The SGW or the PGW starts timing when receiving the update bearer response message.

In this embodiment, when receiving the update bearer response message carrying the routing rule reception response, the SGW or the PGW starts timing according to the bearer resource command message carrying the routing rule timing instruction.

Operation S407. The SGSN sends a modify PDP context accept message to the terminal.

In this embodiment, after sending the routing rule reception response to the SGW or the PGW by using the update bearer response message, the SGSN sends the K routing rules to the terminal by using the modify PDP context accept message.

Operation S408. The terminal sends a modify PDP context request message to the SGSN.

In this embodiment, after the terminal obtains, by using the modify PDP context accept message sent by the SGSN, the K routing rules generated by the SGW or the PGW, the terminal sends routing rule acknowledgement indication information to the SGSN by using the modify PDP context request message.

Operation S409. The SGSN sends a bearer resource command message to the SGW or the PGW.

In this embodiment, the SGSN obtains the routing rule acknowledgement indication information by using the modify PDP context request message sent by the terminal, and then sends the routing rule acknowledgement indication information to the SGW or the PGW by using the bearer resource command message.

Operation S410. If the SGW or the PGW receives, before a timing time reaches a preset time, the bearer resource command message sent by the SGSN, the SGW or the PGW determines, according to the bearer resource command message, a routing rule rejected by the terminal in the K routing rules.

In this embodiment, if the bearer resource command message carrying the routing rule acknowledgement indication information and sent by the SGSN is received before the timing time reaches the preset time, the SGW or the PGW obtains the routing rule acknowledgement indication information in the bearer resource command message, and may determine, according to the routing rule acknowledgement indication information, the routing rule rejected by the terminal in the K routing rules. Then the gateway device does not use N routing rules rejected by the terminal to transmit a traffic flow, but uses M routing rules acknowledged by the terminal to transmit the traffic flow. This ensures consistency of routing rules used by the gateway device and the terminal, and ensures correct transmission of the traffic flow. Optionally, if the bearer resource command message carrying the routing rule acknowledgement indication information and sent by the SGSN is not received before the timing time reaches the preset time, the SGW or the PGW determines all the K routing rules as enforceable routing rules. Then the gateway device may transmit a traffic flow by using the K routing rules.

Operation S411. The SGW or the PGW sends an update bearer request message to the SGSN.

Operation S412. The SGSN sends a modify PDP context accept message to the terminal.

In this embodiment, after performing S410, the SGW or the PGW sends the update bearer request message to the SGSN. The SGSN receives the update bearer request message sent by the SGW or the PGW, and sends the modify PDP context accept message to the terminal.

After receiving the K routing rules by using the modify PDP context accept message, the terminal in this embodiment additionally initiates a PDP context modification process to send the routing rule acknowledgement indication information to the gateway device.

On a basis of the method for routing rule transmission as shown in Embodiment 5 of the present application, optionally, if the terminal sends the NBIFOM routing rule request to the gateway device through a trusted WLAN, the gateway device is the SGW or the PGW. Correspondingly, the SGSN in the foregoing method Embodiment 5 is a TWAG, the modify PDP context request message is a WLCP PDN connection modification request message, and the modify PDP context accept message is a WLCP PDN connection modification response message.

On a basis of the method for routing rule transmission as shown in Embodiment 5 of the present application, optionally, if the terminal sends the NBIFOM routing rule request to the gateway device through an untrusted WLAN, the gateway device is the SGW or the PGW. Correspondingly, the SGSN in the foregoing method Embodiment 5 is an ePDG, the modify PDP context request message is an IKEv2 informational request message, and the modify PDP context accept message is an IKEv2 informational response.

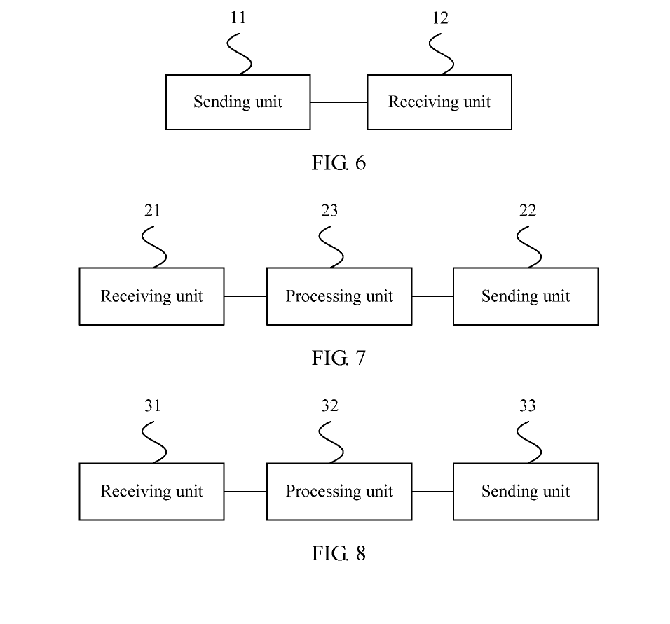

FIG. 6 is a schematic structural diagram of a terminal according to Embodiment 1 of the present application. As shown in FIG. 6, the terminal in this embodiment may include a sending unit 11 and a receiving unit 12. The sending unit 11 is configured to send an NBIFOM routing rule request to an intermediate network device, where the NBIFOM routing rule request includes a routing rule generation parameter. The receiving unit 12 is configured to receive K routing rules sent by the intermediate network device, where K is an integer greater than or equal to 1. The sending unit 11 is further configured to send routing rule acknowledgement indication information to the intermediate network device, where the routing rule acknowledgement indication information includes at least one of the following: identifiers of M routing rules acknowledged by the terminal in the K routing rules and identifiers of N rejected routing rules, where a sum of M and N is equal to K.

Optionally, before sending the NBIFOM routing rule request to the intermediate network device, the sending unit 11 is further configured to: in a process of establishing a PDN connection between the terminal and a gateway device, send a PDN connection establishment request to the gateway device through the intermediate network device, where the PDN connection establishment request carries an NBIFOM mode indication, and the NBIFOM mode indication is used to indicate that a current NBIFOM mode is a network-initiated NBIFOM mode or a terminal-initiated NBIFOM mode, so that the intermediate network device records the current NBIFOM mode.

The terminal in this embodiment may be configured to execute the technical solution executed by the terminal in each of the foregoing method embodiments of the present application. An implementation principle and a technical effect thereof are similar, and are not further described herein.

FIG. 7 is a schematic structural diagram of an intermediate network device according to Embodiment 1 of the present application. As shown in FIG. 7, the intermediate network device in this embodiment may include a receiving unit 21 and a sending unit 22. The receiving unit 21 is configured to receive an NBIFOM routing rule request sent by a terminal, where the NBIFOM routing rule request includes a routing rule generation parameter. The sending unit 22 is configured to send the NBIFOM routing rule request to a gateway device. The receiving unit 21 is further configured to receive K routing rules that are generated by the gateway device according to the NBIFOM routing rule request, where K is an integer greater than or equal to 1. The sending unit 22 is further configured to send the K routing rules to the terminal. The receiving unit 21 is further configured to receive routing rule acknowledgement indication information sent by the terminal, where the routing rule acknowledgement indication information includes at least one of the following: identifiers of M routing rules acknowledged by the terminal in the K routing rules and identifiers of N rejected routing rules, where a sum of M and N is equal to K. The sending unit 22 is further configured to send the routing rule acknowledgement indication information to the gateway device.

Optionally, after the receiving unit 21 receives the NBIFOM routing rule request sent by the terminal, the sending unit 22 is further configured to send a routing rule timing instruction to the gateway device; and after the receiving unit 21 receives the K routing rules that are generated by the gateway device according to the routing rule request, the sending unit 22 is further configured to send a routing rule reception response to the gateway device; where the routing rule timing instruction is used to instruct the gateway device to: start timing when the gateway device receives the routing rule reception response, and determine an enforceable routing rule according to the routing rule acknowledgement indication information if the routing rule acknowledgement indication information is received before a timing time reaches the preset time, or determine the K routing rules as enforceable routing rules if the routing rule acknowledgement indication information is not received before a timing time reaches the preset time.

Optionally, the intermediate network device in this embodiment may further include a processing unit 23, where before the sending unit 22 sends the K routing rules to the terminal, the processing unit 23 is configured to determine that the NBIFOM routing rule request is sent by the terminal in a network-initiated NBIFOM mode.

Optionally, in one embodiment, before receiving the NBIFOM routing rule request sent by the terminal, the receiving unit 21 is further configured to: in a process of establishing a PDN connection between the terminal and the gateway device, receive a PDN connection establishment request sent by the terminal to the gateway device, where the PDN connection establishment request includes an NBIFOM container, and the NBIFOM container carries an NBIFOM mode indication; or receive a PDN connection establishment response sent by the gateway device to the terminal, where the PDN connection establishment response includes an NBIFOM container, and the NBIFOM container carries an NBIFOM mode indication; where the NBIFOM mode indication is used to indicate that a current NBIFOM mode is the network-initiated NBIFOM mode or a terminal-initiated NBIFOM mode;

the processing unit 23 is further configured to parse the NBIFOM container to obtain the NBIFOM mode indication, and record the current NBIFOM mode according to the NBIFOM mode indication; and when determining that the NBIFOM routing rule request is sent by the terminal in the network-initiated NBIFOM mode, the processing unit 23 is specifically configured to determine, according to the current NBIFOM mode recorded as the network-initiated NBIFOM mode, that the NBIFOM routing rule request is sent by the terminal in the network-initiated NBIFOM mode.

In another embodiment, before receiving the NBIFOM routing rule request sent by the terminal, the receiving unit 21 is further configured to: in a process of establishing a PDN connection between the terminal and the gateway device, receive a PDN connection establishment request sent by the terminal to the gateway device, where the PDN connection establishment request carries an NBIFOM mode indication; or receive a PDN connection establishment response sent by the gateway device to the terminal, where the PDN connection establishment response carries an NBIFOM mode indication; where the NBIFOM mode indication is used to indicate that a current NBIFOM mode is the network-initiated NBIFOM mode or a terminal-initiated NBIFOM mode;

the processing unit 23 is further configured to record the current NBIFOM mode according to the NBIFOM mode indication; and

when determining that the NBIFOM routing rule request is sent by the terminal in the network-initiated NBIFOM mode, the processing unit 23 is specifically configured to determine, according to the current NBIFOM mode recorded as the network-initiated NBIFOM mode, that the NBIFOM routing rule request is sent by the terminal in the network-initiated NBIFOM mode.

In another embodiment, the NBIFOM routing rule request further includes a first indication, and the first indication is used to indicate whether a current access network is available to the terminal, or used to indicate that a traffic flow of the terminal in the current corresponding access network needs to be transferred from an RAN to a WLAN or from a WLAN to an RAN, or used to indicate that a type of the NBIFOM routing rule request is a traffic flow mapping request; and when determining that the NBIFOM routing rule request is sent by the terminal in the network-initiated NBIFOM mode, the processing unit 23 is specifically configured to determine, according to the first indication, that the NBIFOM routing rule request is sent by the terminal in the network-initiated NBIFOM mode.

The intermediate network device in this embodiment may be configured to execute the technical solution executed by the intermediate network device in each of the foregoing method embodiments of the present application. An implementation principle and a technical effect thereof are similar, and are not further described herein.

FIG. 8 is a schematic structural diagram of a gateway device according to Embodiment 1 of the present application. As shown in FIG. 8, the gateway device in this embodiment may include a receiving unit 31, a processing unit 32, and a sending unit 33. The receiving unit 31 is configured to receive an NBIFOM routing rule request sent by an intermediate network device, where the NBIFOM routing rule request includes a routing rule generation parameter. The processing unit 32 is configured to generate K routing rules according to the NBIFOM routing rule request, where K is an integer greater than or equal to 1. The sending unit 33 is configured to send the K routing rules to the intermediate network device. The receiving unit 31 is further configured to receive routing rule acknowledgement indication information sent by the intermediate network device, where the routing rule acknowledgement indication information includes at least one of the following: identifiers of M routing rules acknowledged by a terminal in the K routing rules and identifiers of N rejected routing rules, where a sum of M and N is equal to K. The processing unit 32 is further configured to determine, according to the routing rule acknowledgement indication information, the N routing rules rejected by the terminal in the K routing rules.

Optionally, after receiving the NBIFOM routing rule request sent by the intermediate network device, the receiving unit 31 is further configured to receive a routing rule timing instruction sent by the intermediate network device;

after the sending unit 33 sends the K routing rules to the intermediate network device, the receiving unit 31 is further configured to receive a routing rule reception response sent by the intermediate network device;

the processing unit 32 is further configured to start timing according to the routing rule timing instruction when the routing rule reception response is received; and

when receiving the routing rule acknowledgement indication information sent by the intermediate network device, the receiving unit 31 is specifically configured to receive the routing rule acknowledgement indication information before a timing time reaches a preset time.

Optionally, if determining that the receiving unit 31 does not receive the routing rule acknowledgement indication information before the timing time reaches the preset time, the processing unit 32 is further configured to determine that the K routing rules are enforceable routing rules.

Optionally, before the receiving unit 31 receives the NBIFOM routing rule request sent by the intermediate network device, the sending unit 33 is further configured to: in a process of establishing a PDN connection between the gateway device and the terminal, send a PDN connection establishment response to the terminal through the intermediate network device, where the PDN connection establishment response carries an NBIFOM mode indication, and the NBIFOM mode indication is used to indicate that a current NBIFOM mode is a network-initiated NBIFOM mode or a terminal-initiated NBIFOM mode, so that the intermediate network device records the current NBIFOM mode.

The gateway device in this embodiment may be configured to execute the technical solution executed by the gateway device in each of the foregoing method embodiments of the present application. An implementation principle and a technical effect thereof are similar, and are not further described herein.

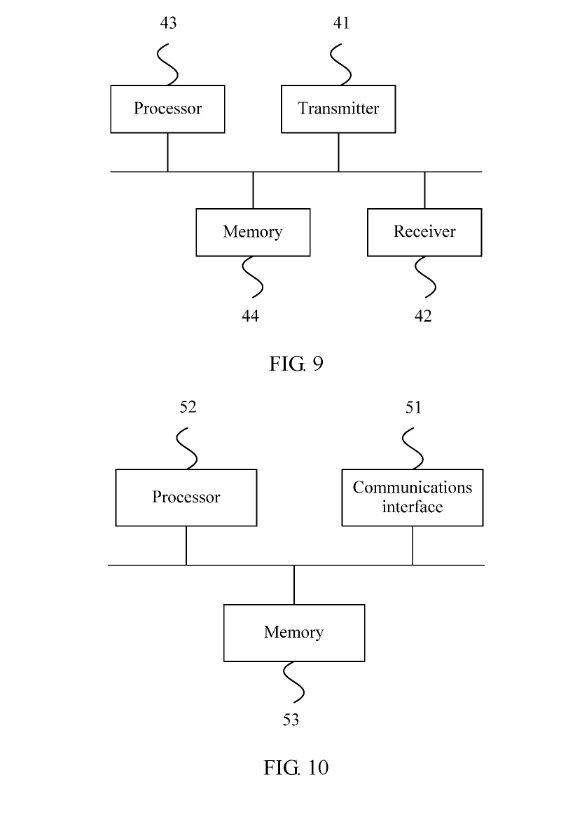

FIG. 9 is a schematic structural diagram of a terminal according to Embodiment 2 of the present application. As shown in FIG. 9, the terminal in this embodiment may include a transmitter 41, a receiver 42, a processor 43, and a memory 44. The memory 44 is configured to store program code for performing a method for routing rule transmission. The processor 43 is configured to invoke the program code in the memory 44 to perform:

sending an NBIFOM routing rule request to an intermediate network device by using the transmitter 41, where the NBIFOM routing rule request includes a routing rule generation parameter; receiving, by using the receiver 42, K routing rules sent by the intermediate network device, where K is an integer greater than or equal to 1; and sending routing rule acknowledgement indication information to the intermediate network device by using the transmitter 41, where the routing rule acknowledgement indication information includes at least one of the following: identifiers of M routing rules acknowledged by the terminal in the K routing rules and identifiers of N rejected routing rules, where a sum of M and N is equal to K.

Optionally, before sending the NBIFOM routing rule request to the intermediate network device by using the transmitter 41, the processor 43 is further configured to: in a process of establishing a PDN connection between the terminal and a gateway device, send a PDN connection establishment request to the gateway device through the intermediate network device by using the transmitter 41, where the PDN connection establishment request carries an NBIFOM mode indication, and the NBIFOM mode indication is used to indicate that a current NBIFOM mode is a network-initiated NBIFOM mode or a terminal-initiated NBIFOM mode, so that the intermediate network device records the current NBIFOM mode.

The terminal in this embodiment may be configured to execute the technical solution executed by the terminal in each of the foregoing method embodiments of the present application. An implementation principle and a technical effect thereof are similar, and are not further described herein.

FIG. 10 is a schematic structural diagram of an intermediate network device according to Embodiment 2 of the present application. As shown in FIG. 10, the intermediate network device in this embodiment may include a communications interface 51, a processor 52, and a memory 53. The memory 53 is configured to store program code for performing a method for routing rule transmission. The processor 52 is configured to invoke the program code in the memory 53 to perform:

receiving, by using the communications interface 51, an NBIFOM routing rule request sent by a terminal, and sending the NBIFOM routing rule request to a gateway device by using the communications interface 51, where the NBIFOM routing rule request includes a routing rule generation parameter; receiving, by using the communications interface 51, K routing rules that are generated by the gateway device according to the NBIFOM routing rule request, and sending the K routing rules to the terminal by using the communications interface 51, where K is an integer greater than or equal to 1; and receiving, by using the communications interface 51, routing rule acknowledgement indication information sent by the terminal, and sending the routing rule acknowledgement indication information to the gateway device by using the communications interface 51, where the routing rule acknowledgement indication information includes at least one of the following: identifiers of M routing rules acknowledged by the terminal in the K routing rules and identifiers of N rejected routing rules, where a sum of M and N is equal to K.

Optionally, after receiving, by using the communications interface 51, the NBIFOM routing rule request sent by the terminal, the processor 52 is further configured to send a routing rule timing instruction to the gateway device by using the communications interface 51; and after receiving, by using the communications interface 51, the K routing rules that are generated by the gateway device according to the routing rule request, the processor 52 is further configured to send a routing rule reception response to the gateway device by using the communications interface 51; where the routing rule timing instruction is used to instruct the gateway device to: start timing when the gateway device receives the routing rule reception response, and determine an enforceable routing rule according to the routing rule acknowledgement indication information if the routing rule acknowledgement indication information is received before a timing time reaches the preset time, or determine the K routing rules as enforceable routing rules if the routing rule acknowledgement indication information is not received before a timing time reaches the preset time.

Optionally, before sending the K routing rules to the terminal by using the communications interface 51, the processor 52 is further configured to determine that the NBIFOM routing rule request is sent by the terminal in a network-initiated NBIFOM mode.

Optionally, in one embodiment, before receiving, by using the communications interface 51, the NBIFOM routing rule request sent by the terminal, the processor 52 is further configured to: in a process of establishing a PDN connection between the terminal and the gateway device, receive, by using the communications interface 51, a PDN connection establishment request sent by the terminal to the gateway device, where the PDN connection establishment request includes an NBIFOM container, and the NBIFOM container carries an NBIFOM mode indication; or receive, by using the communications interface 51, a PDN connection establishment response sent by the gateway device to the terminal, where the PDN connection establishment response includes an NBIFOM container, and the NBIFOM container carries an NBIFOM mode indication; where the NBIFOM mode indication is used to indicate that a current NBIFOM mode is the network-initiated NBIFOM mode or a terminal-initiated NBIFOM mode;

the processor 52 is further configured to parse the NBIFOM container to obtain the NBIFOM mode indication, and record the current NBIFOM mode according to the NBIFOM mode indication; and when determining that the NBIFOM routing rule request is sent by the terminal in the network-initiated NBIFOM mode, the processor 52 is specifically configured to determine, according to the current NBIFOM mode recorded as the network-initiated NBIFOM mode, that the NBIFOM routing rule request is sent by the terminal in the network-initiated NBIFOM mode.

In another embodiment, before receiving, by using the communications interface 51, the NBIFOM routing rule request sent by the terminal, the processor 52 is further configured to: in a process of establishing a PDN connection between the terminal and the gateway device, receive, by using the communications interface 51, a PDN connection establishment request sent by the terminal to the gateway device, where the PDN connection establishment request carries an NBIFOM mode indication; or receive, by using the communications interface 51, a PDN connection establishment response sent by the gateway device to the terminal, where the PDN connection establishment response carries an NBIFOM mode indication; where the NBIFOM mode indication is used to indicate that a current NBIFOM mode is the network-initiated NBIFOM mode or a terminal-initiated NBIFOM mode;

the processor 52 is further configured to record the current NBIFOM mode according to the NBIFOM mode indication; and

when determining that the NBIFOM routing rule request is sent by the terminal in the network-initiated NBIFOM mode, the processor 52 is specifically configured to determine, according to the current NBIFOM mode recorded as the network-initiated NBIFOM mode, that the NBIFOM routing rule request is sent by the terminal in the network-initiated NBIFOM mode.

In another embodiment, the NBIFOM routing rule request further includes a first indication, and the first indication is used to indicate whether a current access network is available to the terminal, or used to indicate that a traffic flow of the terminal in the current corresponding access network needs to be transferred from an RAN to a WLAN or from a WLAN to an RAN, or used to indicate that a type of the NBIFOM routing rule request is a traffic flow mapping request; and when determining that the NBIFOM routing rule request is sent by the terminal in the network-initiated NBIFOM mode, the processor 52 is specifically configured to determine, according to the first indication, that the NBIFOM routing rule request is sent by the terminal in the network-initiated NBIFOM mode.

The intermediate network device in this embodiment may be configured to execute the technical solution executed by the intermediate network device in each of the foregoing method embodiments of the present application. An implementation principle and a technical effect thereof are similar, and are not further described herein.

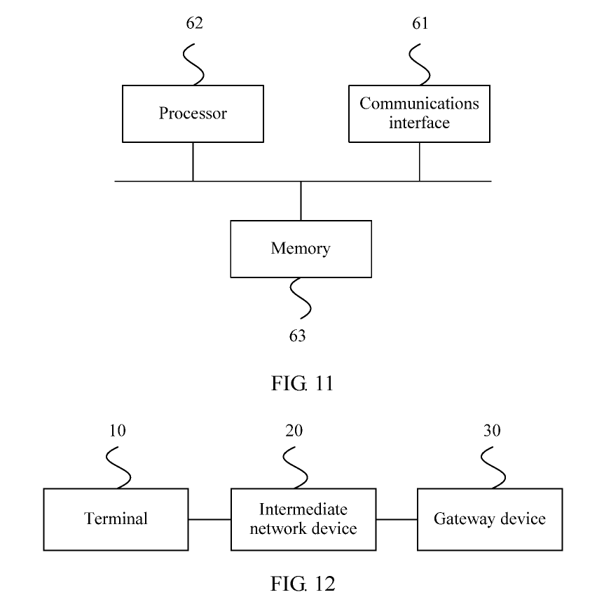

FIG. 11 is a schematic structural diagram of a gateway device according to Embodiment 2 of the present application. As shown in FIG. 11, the gateway device in this embodiment may include a communications interface 61, a processor 62, and a memory 63. The memory 63 is configured to store program code for performing a method for routing rule transmission. The processor 62 is configured to invoke the program code in the memory 63 to perform:

receiving, by using the communications interface 61, an NBIFOM routing rule request sent by an intermediate network device, where the NBIFOM routing rule request includes a routing rule generation parameter; generating K routing rules according to the NBIFOM routing rule request, where K is an integer greater than or equal to 1; sending the K routing rules to the intermediate network device by using the communications interface 61; receiving, by using the communications interface 61, routing rule acknowledgement indication information sent by the intermediate network device, where the routing rule acknowledgement indication information includes at least one of the following: identifiers of M routing rules acknowledged by a terminal in the K routing rules and identifiers of N rejected routing rules, where a sum of M and N is equal to K; and determining, according to the routing rule acknowledgement indication information, the N routing rules rejected by the terminal in the K routing rules.

Optionally, after receiving, by using the communications interface 61, the NBIFOM routing rule request sent by the intermediate network device, the processor 62 is further configured to receive, by using the communications interface 61, a routing rule timing instruction sent by the intermediate network device;

after sending the K routing rules to the intermediate network device by using the communications interface 61, the processor 62 is further configured to receive, by using the communications interface 61, a routing rule reception response sent by the intermediate network device;

the processor 62 is further configured to start timing according to the routing rule timing instruction when the routing rule reception response is received; and

when receiving, by using the communications interface 61, the routing rule acknowledgement indication information sent by the intermediate network device, the processor 62 is specifically configured to receive the routing rule acknowledgement indication information by using the communications interface 61 before a timing time reaches the preset time.

Optionally, if determining that the routing rule acknowledgement indication information is not received by using the communications interface 61 before the timing time reaches the preset time, the processor 62 is further configured to determine that the K routing rules are enforceable routing rules.

Optionally, before receiving, by using the communications interface 61, the NBIFOM routing rule request sent by the intermediate network device, the processor 62 is further configured to: in a process of establishing a PDN connection between the gateway device and the terminal, send a PDN connection establishment response to the terminal through the intermediate network device by using the communications interface 61, where the PDN connection establishment response carries an NBIFOM mode indication, and the NBIFOM mode indication is used to indicate that a current NBIFOM mode is a network-initiated NBIFOM mode or a terminal-initiated NBIFOM mode, so that the intermediate network device records the current NBIFOM mode.

The gateway device in this embodiment may be configured to execute the technical solution executed by the gateway device in each of the foregoing method embodiments of the present application. An implementation principle and a technical effect thereof are similar, and are not further described herein.

FIG. 12 is a schematic structural diagram of a system for routing rule transmission according to an embodiment of the present application. As shown in FIG. 12, the system in this embodiment includes a terminal 10, an intermediate network device 20, and a gateway device 30. The terminal 10 may use a structure of the terminal provided by Embodiment 1 or Embodiment 2 of the present application, and the terminal 10 may correspondingly execute the technical solution executed by the terminal in each of the foregoing method embodiments of the present application. An implementation principle and a technical effect thereof are similar, and are not further described herein. The intermediate network device 20 may use a structure of the intermediate network device provided by Embodiment 1 or Embodiment 2 of the present application, and the intermediate network device 20 may correspondingly execute the technical solution executed by the intermediate network device in each of the foregoing method embodiments of the present application. An implementation principle and a technical effect thereof are similar, and are not further described herein. The gateway device 30 may use a structure of the gateway device provided by Embodiment 1 or Embodiment 2 of the present application, and the gateway device 30 may correspondingly execute the technical solution executed by the gateway device in each of the foregoing method embodiments of the present application. An implementation principle and a technical effect thereof are similar, and are not further described herein. It should be noted that, the terminal 10 communicates with the intermediate network device 20 through an access network (not shown in the figure). Depending on different access networks, the intermediate network device 20 also varies correspondingly.

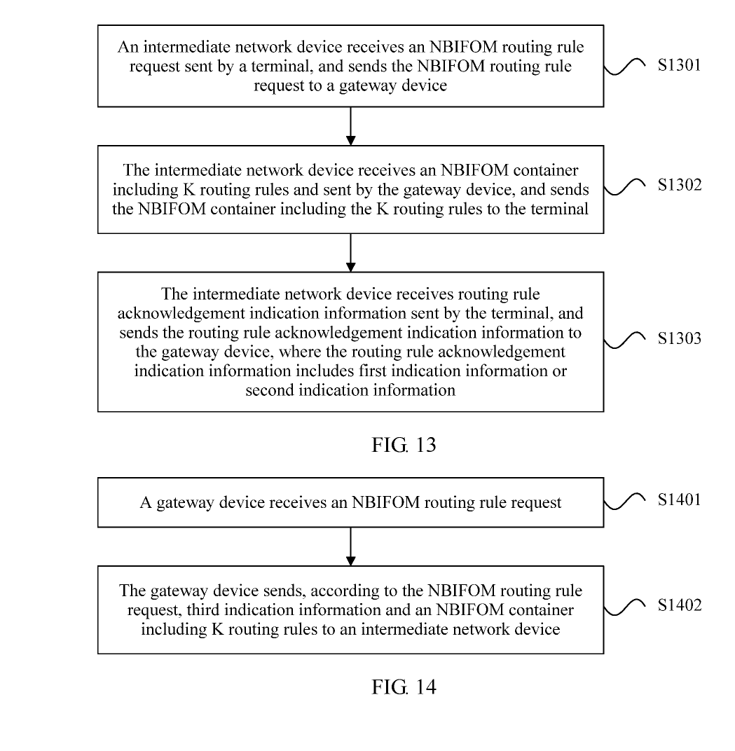

FIG. 13 is a flowchart of a method for routing rule transmission according to Embodiment 6 of the present application. As shown in FIG. 13, the method includes the following operations.

Operation S1301. An intermediate network device receives an NBIFOM routing rule request sent by a terminal, and sends the NBIFOM routing rule request to a gateway device.

The NBIFOM routing rule request may include a routing rule generation parameter. Specifically, the routing rule generation parameter may include at least one of an IP flow mapping (IP flow mapping), an RAN rule indication, or an access network unavailability/availability indication. Specifically, if a network agrees to the IP flow mapping carried in the NBIFOM routing rule request, the network generates a routing rule according to the IP flow mapping. The RAN rule indication is used to indicate whether to allow a handover between heterogeneous networks, for example, a handover from 3GPP to a WLAN or a handover from a WLAN to 3GPP. The access network availability/unavailability indication is used to indicate whether an access network is available. If the access network availability/unavailability indication indicates that the access network is unavailable, all services of the access network are handed over to another access network.

In addition, the NBIFOM routing rule request includes an NBIFOM container. The intermediate network device may identify, by determining whether a message sent by the terminal carries the NBIFOM container, whether the message is an NBIFOM routing rule request message, that is, if the message sent by the terminal carries the NBIFOM container, the intermediate network device considers that the message is the NBIFOM routing rule request.

Operation S1302. The intermediate network device receives an NBIFOM container including K routing rules and sent by the gateway device, and sends the NBIFOM container including the K routing rules to the terminal.

K is an integer greater than or equal to 1.

Operation S1303. The intermediate network device receives routing rule acknowledgement indication information sent by the terminal, and sends the routing rule acknowledgement indication information to the gateway device, where the routing rule acknowledgement indication information includes first indication information or second indication information.

The first indication information is used to indicate that the terminal accepts the K routing rules, and the second indication information is used to indicate that the terminal rejects at least one of the K routing rules.

Optionally, in a first implementation scenario of the this embodiment, after operation S1301, the method further includes: the intermediate network device determines whether third indication information is received from the gateway device; and if the intermediate network device determines that the third indication information is received from the gateway device, the intermediate network device sends an acknowledgement message to the terminal.

The third indication information is used to instruct the intermediate network device to send an acknowledgement message that does not carry any routing rule to the terminal. The acknowledgement message does not carry the NBIFOM container including the K routing rules, and the acknowledgement message is used to acknowledge reception of the NBIFOM routing rule request sent by the terminal.

Optionally, in a second implementation scenario of the this embodiment, that the intermediate network device sends the NBIFOM container including the K routing rules to the terminal in operation S1302 includes:

the intermediate network device determines whether third indication information is received from the gateway device; and if the intermediate network device determines that the third indication information is received from the gateway device, the intermediate network device sends a first request message to the terminal, where the first request message carries the NBIFOM container including the K routing rules.

The third indication information is used to indicate that a feedback of the terminal is required for an NBIFOM container sent by the intermediate network device, or the third indication information is used to instruct the intermediate network device to send an NBIFOM container to the terminal by using a request message.

Specifically, the first request message may be a request secondary packet data protocol (Packet Data Protocol, PDP) context activation message or a modify PDP context request message.

Further, based on the second implementation scenario, the method may include:

Operation S1304. The intermediate network device sends an acknowledgement message to the terminal, where the acknowledgement message does not carry the NBIFOM container including the K routing rules, and the acknowledgement message is used to acknowledge reception of the NBIFOM routing rule request sent by the terminal.

It should be noted that, an execution sequence of operations S1304, S1302, and S1303 in this embodiment of the present application may be changed and is not limited.

Optionally, based on the this embodiment or the first or the second implementation scenario of the this embodiment, the method further includes:

Operation S1305. The intermediate network device receives the third indication information from the gateway device.

The third indication information and the NBIFOM container including the K routing rules may be both carried in a create bearer request message or an update bearer request message; or the third indication information is carried in a create session response message, and the NBIFOM container including the K routing rules is carried in a create bearer request message or an update bearer request message.

It should be noted that, for descriptions about the routing rules, the gateway device, and the intermediate network device, reference may be made to other embodiments of the present application. Details are not further described herein.

In the foregoing solution of this embodiment, the gateway device determines, according to the routing rule acknowledgement indication information, a routing rule accepted by the terminal, and transmits a traffic flow by using the routing rule accepted by the terminal. This ensures consistency of routing rules used by the gateway device and the terminal, and ensures correct transmission of the traffic flow.

FIG. 14 is a flowchart of a method for routing rule transmission according to Embodiment 7 of the present application. As shown in FIG. 14, the method includes the following operations.

Operation S1401. A gateway device receives an NBIFOM routing rule request.

Operation S1402. The gateway device sends, according to the NBIFOM routing rule request, third indication information and an NBIFOM container including K routing rules to an intermediate network device.

K is an integer greater than or equal to 1, and the third indication information is used to instruct the intermediate network device to send an acknowledgement message that does not carry any routing rule to a terminal, or the third indication information is used to indicate that a feedback of a terminal is required for an NBIFOM container sent by the intermediate network device, or the third indication information is used to instruct the intermediate network device to send an NBIFOM container to a terminal by using a request message.

Optionally, the NBIFOM routing rule request includes a routing rule generation parameter of the terminal. The routing rule generation parameter may include at least one of an IP flow mapping (IP flow mapping), an RAN rule indication, or an access network unavailability/availability indication. Specifically, if a network agrees to the IP flow mapping carried in the NBIFOM routing rule request, the network generates a routing rule according to the IP flow mapping. The RAN rule indication is used to indicate whether to allow a handover between heterogeneous networks, for example, a handover from 3GPP to a WLAN or a handover from a WLAN to 3GPP. The access network availability/unavailability indication is used to indicate whether an access network is available. If the access network availability/unavailability indication indicates that the access network is unavailable, all services of the access network are handed over to another access network.

A feasible implementation of the foregoing S1402 in which the gateway device sends, according to the NBIFOM routing rule request, the NBIFOM container including K routing rules to the intermediate network device is: the gateway device generates the K routing rules according to the NBIFOM routing rule request, and then sends the NBIFOM container including the K routing rules to the intermediate network device. Optionally, if the NBIFOM routing rule request includes the routing rule generation parameter of the terminal, that the gateway device generates the K routing rules according to the NBIFOM routing rule request includes: generating the K routing rules according to the routing rule generation parameter of the terminal.

Another feasible implementation of the foregoing S1402 in which the gateway device sends, according to the NBIFOM routing rule request, the NBIFOM container including K routing rules to the intermediate network device is: the gateway device sends a policy control and charging (PCC) rule request to a PCRF according to the NBIFOM routing rule request; and then the gateway device receives a PCC rule generated by the PCRF, generates the K routing rules according to the PCC rule, and then sends the NBIFOM container including the K routing rules to the intermediate network device. Optionally, the gateway device may send the PCC rule request to the PCRF by using an IP-connectivity access network (IP-CAN) session modification indication message, for example, the IP-CAN session modification indication message carries the PCC rule request; and the gateway device receives, by using an acknowledge IP-CAN session modification message, the PCC rule sent by the PCRF, for example, the acknowledge IP-CAN session modification message carries the PCC rule.

In this embodiment, the gateway device sends the third indication information and the NBIFOM container including the K routing rules to the intermediate network device; and correspondingly, for an operation after the intermediate network device receives the third indication information and the NBIFOM container including the K routing rules that are sent by the gateway device, refer to related descriptions in the embodiment shown in FIG. 13. Details are not further described herein.

Optionally, the third indication information and the K routing rules are both carried in a create bearer request message or an update bearer request message.

Optionally, that the gateway device sends third indication information to an intermediate network device in operation S1402 includes: if a PDN connection of the terminal is in a network-initiated NBIFOM mode, the gateway device sends the third indication information to the intermediate network device.

Optionally, before operation S1401, the method further includes:

the gateway device receives mode indication information sent by the PCRF, where the mode indication information is used to indicate the mode of the PDN connection of the terminal; and the gateway device stores the mode indication information.

In the foregoing solution of this embodiment, the gateway device determines, according to routing rule acknowledgement indication information, a routing rule accepted by the terminal, and transmits a traffic flow by using the routing rule accepted by the terminal. This ensures consistency of routing rules used by the gateway device and the terminal, and ensures correct transmission of the traffic flow.

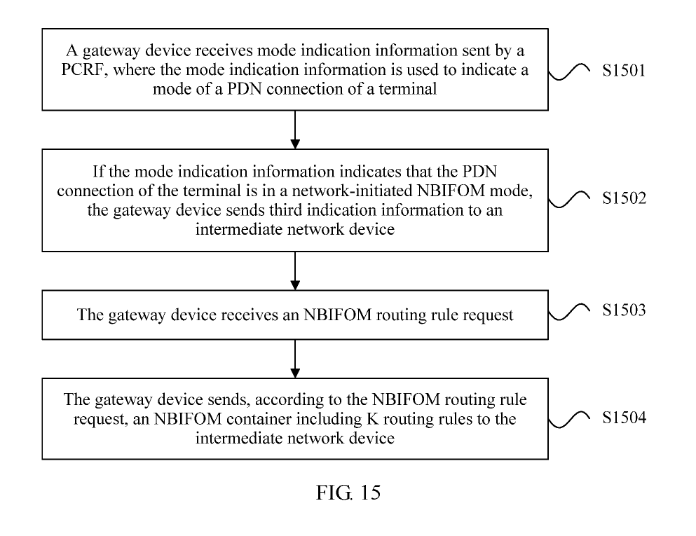

FIG. 15 is a flowchart of a method for routing rule transmission according to Embodiment 8 of the present application. As shown in FIG. 15, the method includes the following operations.

Operation S1501. A gateway device receives mode indication information sent by a PCRF, where the mode indication information is used to indicate a mode of a PDN connection of a terminal.

Operation S1502. If the mode indication information indicates that the PDN connection of the terminal is in a network-initiated NBIFOM mode, the gateway device sends third indication information to an intermediate network device.

The third indication information is used to instruct the intermediate network device to send an acknowledgement message that does not carry any routing rule to the terminal, or the third indication information is used to indicate that a feedback of the terminal is required for an NBIFOM container sent by the intermediate network device, or the third indication information is used to instruct the intermediate network device to send an NBIFOM container to the terminal by using a request message.

The third indication information may be carried in a create session response message and sent to the intermediate network device.

Operation S1503. The gateway device receives an NBIFOM routing rule request.

For details about the NBIFOM routing rule request, refer to related descriptions in the embodiment shown in FIG. 14.

It should be noted that, S1503 is performed after S1502 in this embodiment, and other actions may be further performed between S1502 and S1503.

Operation S1504. The gateway device sends, according to the NBIFOM routing rule request, an NBIFOM container including K routing rules to the intermediate network device.

For operation S1504, refer to related descriptions in operation S1402 in the embodiment shown in FIG. 14.

Correspondingly, for an operation behavior after the intermediate network device receives the third indication information sent by the gateway device and an operation behavior after the intermediate network device receives the NBIFOM container including the K routing rules, refer to related descriptions in the embodiment shown in FIG. 13. Details are not further described herein.

In the foregoing solution of this embodiment, the gateway device determines, according to routing rule acknowledgement indication information, a routing rule accepted by the terminal, and transmits a traffic flow by using the routing rule accepted by the terminal. This ensures consistency of routing rules used by the gateway device and the terminal, and ensures correct transmission of the traffic flow.

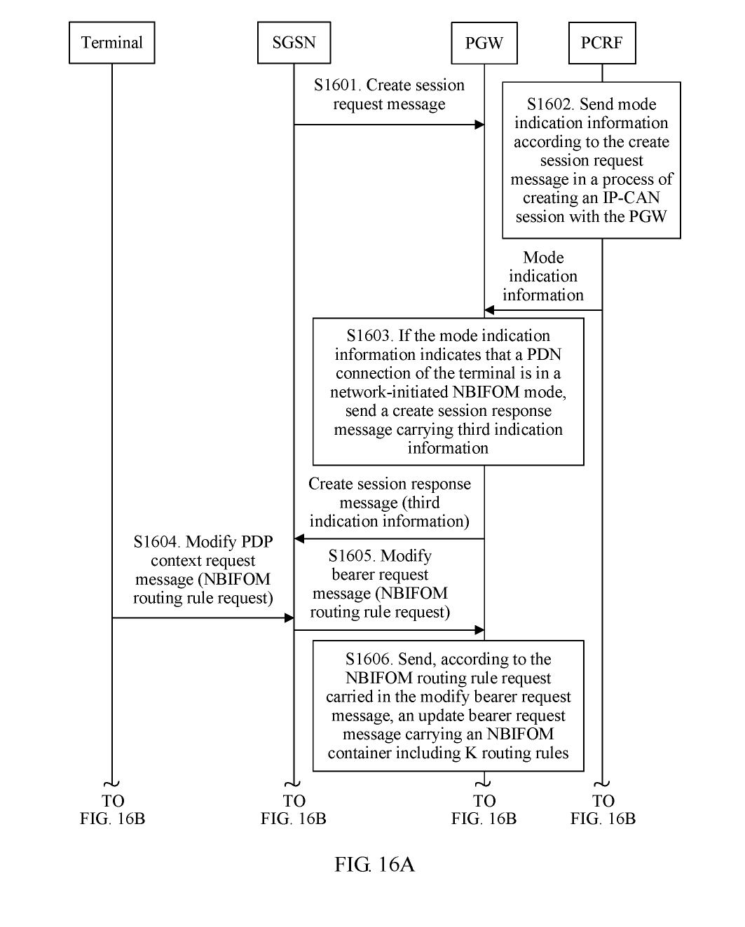

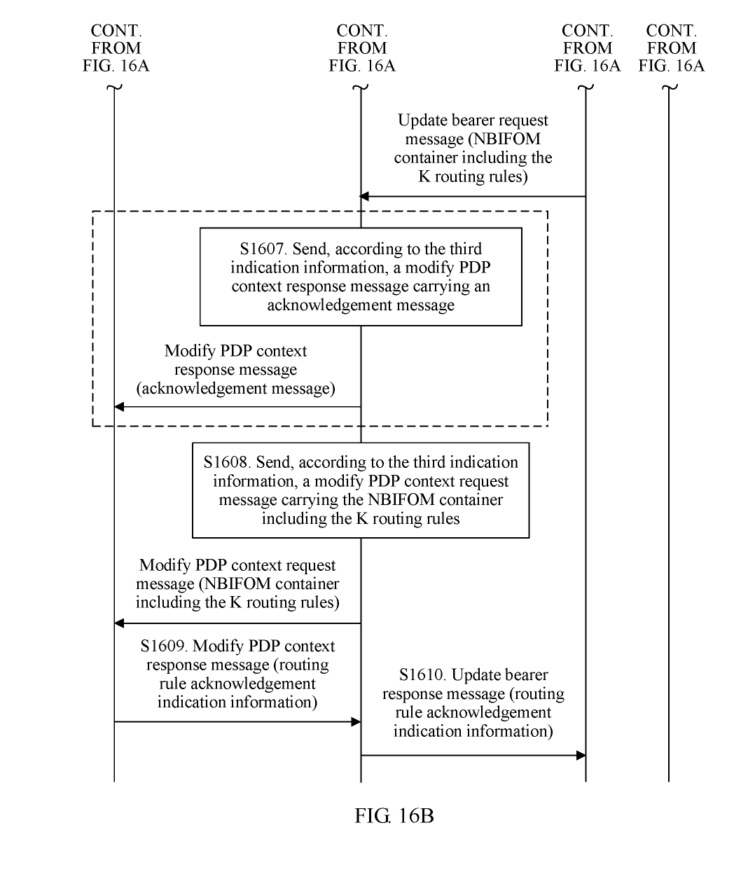

FIG. 16A and FIG. 16B are a flowchart of a method for routing rule transmission according to Embodiment 9 of the present application. As shown in FIG. 16A and FIG. 16B, in this embodiment, for example, a terminal sends an NBIFOM routing rule request to a gateway device through an RAN, the gateway device is a PGW, and correspondingly, an intermediate network device is an SGSN. The method in this embodiment may include the following operations.

Operation S1601. An SGSN sends a create session request message to a PGW.

Operation S1602. A PCRF sends mode indication information to the PGW according to the create session request message in a process of creating an IP-CAN session with the PGW.

Specifically, in an initial PDN connection establishment process, the SGSN sends the create session request message to the PGW. After receiving the create session request message, the PGW receives the mode indication information sent by the PCRF in the process of creating the IP-CAN session with the PCRF. The mode indication information is used to indicate a mode of a PDN connection of a terminal. For example, the PDN connection of the terminal is in a network-initiated NBIFOM mode.

Operation S1603. If the mode indication information indicates that a PDN connection of a terminal is in a network-initiated NBIFOM mode, the PGW sends a create session response message carrying third indication information to the SGSN.

The third indication information is used to instruct the SGSN to send an acknowledgement message that does not carry any routing rule to the terminal; or the third indication information is used to indicate that a feedback of the terminal is required for an NBIFOM container sent by the SGSN; or the third indication information is used to instruct the SGSN to send an NBIFOM container to the terminal by using a request message.

Operation S1604. The terminal sends a modify PDP context request message carrying an NBIFOM routing rule request to the SGSN.

Operation S1605. The SGSN sends a modify bearer request message carrying the NBIFOM routing rule request to the PGW.

In this embodiment, the SGSN receives the modify PDP context request message that carries the NBIFOM routing rule request and is sent by the terminal, and sends the NBIFOM routing rule request to the PGW by using the modify bearer request message.

Operation S1606. The PGW sends, according to the NBIFOM routing rule request carried in the modify bearer request message, an update bearer request message carrying an NBIFOM container including K routing rules to the SGSN.

In this embodiment, for operation S1606, refer to related descriptions in operation S1402 in the embodiment shown in FIG. 14.

In this embodiment, after the SGSN receives the NBIFOM container including the K routing rules, and determines that the third indication information is received from the PGW, as described in S1603, there are the following two implementations for the SGSN.

In a first implementation, if the third indication information is used to instruct the SGSN to send the acknowledgement message that does not carry any routing rule to the terminal, in this embodiment, after S1606 is performed, the following operations S1607 to S1610 are performed.

Operation S1607. The SGSN sends, according to the third indication information, a modify PDP context response message carrying an acknowledgement message to the terminal.

In this embodiment, the SGSN sends, according to the third indication information that is used to instruct the SGSN to send the acknowledgement message that does not carry any routing rule to the terminal, the acknowledgement message to the terminal by using the modify PDP context response message. The acknowledgement message does not carry the NBIFOM container including the K routing rules, and the acknowledgement message is used to acknowledge reception of the NBIFOM routing rule request sent by the terminal. In this embodiment, after S1607 is performed, S1608 to S1610 are performed.

In a second implementation, if the third indication information is used to indicate that the feedback of the terminal is required for the NBIFOM container sent by the SGSN, or the third indication information is used to instruct the SGSN to send the NBIFOM container to the terminal by using the request message, in this embodiment, after S1606 is performed, the following operations S1608 to S1610 are performed.

Operation S1608. The SGSN sends, according to the third indication information, a modify PDP context request message carrying the NBIFOM container including the K routing rules to the terminal.

Operation S1609. The terminal sends a modify PDP context response message carrying routing rule acknowledgement indication information to the SGSN.

In this embodiment, after the terminal obtains, by using the modify PDP context request message sent by the SGSN, the NBIFOM container including the K routing rules generated by the PGW, the terminal sends the routing rule acknowledgement indication information to the SGSN by using the modify PDP context response message. The routing rule acknowledgement indication information includes first indication information or second indication information, the first indication information is used to indicate that the terminal accepts the K routing rules, and the second indication information is used to indicate that the terminal rejects at least one of the K routing rules.

Operation S1610. The SGSN sends an update bearer response message carrying the routing rule acknowledgement indication information to the PGW.

In this embodiment, the SGSN obtains the routing rule acknowledgement indication information by using the modify PDP context response message sent by the terminal, and then sends the routing rule acknowledgement indication information to the PGW by using the update bearer response message.

In this embodiment, the PGW receives the update bearer response message sent by the SGSN, obtains the routing rule acknowledgement indication information in the update bearer response message, determines, according to the routing rule acknowledgement indication information, a routing rule accepted by the terminal, and transmits a traffic flow by using the routing rule accepted by the terminal. This ensures consistency of routing rules used by the gateway device and the terminal, and ensures correct transmission of the traffic flow.

Optionally, the update bearer request message in S1606 may be a create bearer request message; correspondingly, the modify PDP context request message in S1608 may be a request secondary PDP context activation message; the modify PDP context response message in S1609 may be an activate secondary PDP context request message; and the update bearer response message in S1610 may be a create bearer response message.

Optionally, the PGW may be replaced with an SGW. Details are not further described.

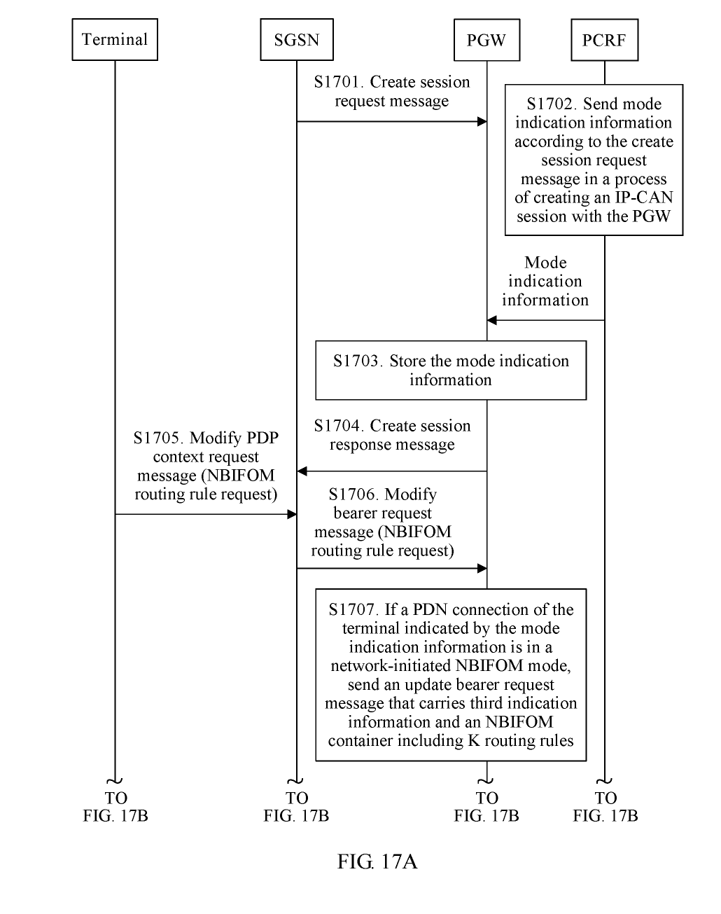

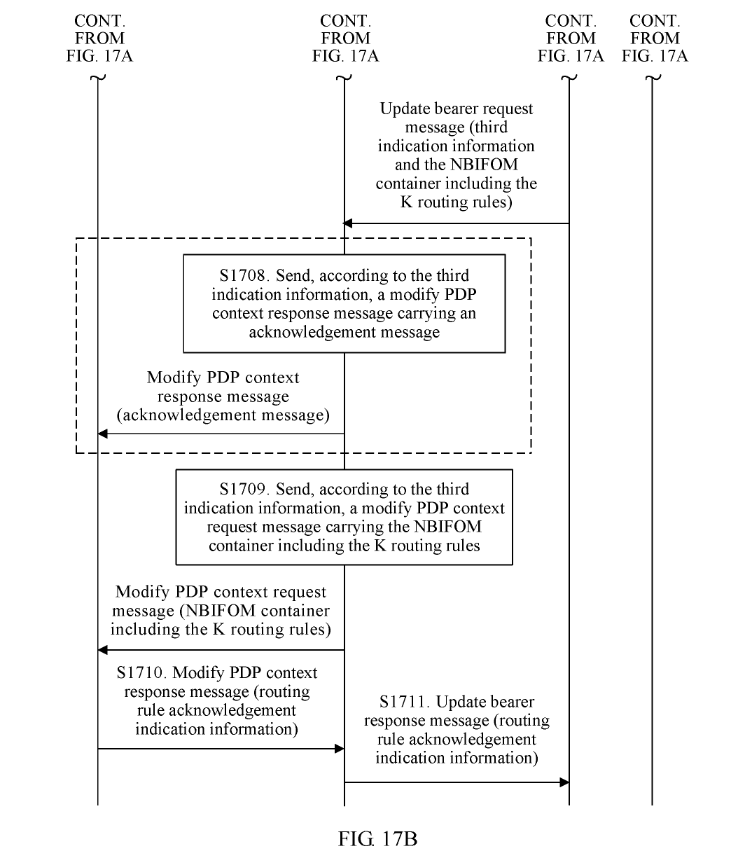

FIG. 17A and FIG. 17B are a flowchart of a method for routing rule transmission according to Embodiment 10 of the present application. As shown in FIG. 17A and FIG. 17B, in this embodiment, for example, a terminal sends an NBIFOM routing rule request to a gateway device through an RAN, the gateway device is a PGW, and correspondingly, an intermediate network device is an SGSN. The method in this embodiment may include the following operations.

Operation S1701. An SGSN sends a create session request message to a PGW.

Operation S1702. A PCRF sends mode indication information to the PGW according to the create session request message in a process of creating an IP-CAN session with the PGW.

The mode indication information is used to indicate a mode of a PDN connection of a terminal. For example, the PDN connection of the terminal is in a network-initiated NBIFOM mode.

Operation S1703. The PGW stores the mode indication information.

In this embodiment, after receiving the mode indication information sent by the PCRF, the PGW stores the mode indication information.

Operation S1704. The PGW sends a create session response message to the SGSN.

This embodiment differs from the embodiment shown in FIG. 16A and FIG. 16B in that the create session response message does not carry third indication information.

Operation S1705. A terminal sends a modify PDP context request message carrying an NBIFOM routing rule request to the SGSN.

Operation S1706. The SGSN sends a modify bearer request message carrying the NBIFOM routing rule request to the PGW.

Operation S1707. If a PDN connection of the terminal indicated by the mode indication information is in a network-initiated NBIFOM mode, the PGW sends an update bearer request message that carries third indication information and an NBIFOM container including K routing rules to the SGSN.

The third indication information is used to instruct the SGSN to send an acknowledgement message that does not carry any routing rule to the terminal; or the third indication information is used to indicate that a feedback of the terminal is required for an NBIFOM container sent by the SGSN, or the third indication information is used to instruct the SGSN to send an NBIFOM container to the terminal by using a request message.

In this embodiment, after the SGSN receives the NBIFOM container including the K routing rules, and determines that the third indication information is received from the PGW (as described in S1707), there are the following two implementations for the SGSN.

In a first implementation, if the third indication information is used to instruct the SGSN to send the acknowledgement message that does not carry any routing rule to the terminal, in this embodiment, after S1707 is performed, the following operations S1708 to S1711 are performed.

Operation S1708. The SGSN sends, according to the third indication information, a modify PDP context response message carrying an acknowledgement message to the terminal.

In this embodiment, the SGSN sends, according to the third indication information that is used to instruct the SGSN to send the acknowledgement message that does not carry any routing rule to the terminal, the acknowledgement message to the terminal by using the modify PDP context response message. The acknowledgement message does not carry the NBIFOM container including the K routing rules, and the acknowledgement message is used to acknowledge reception of the NBIFOM routing rule request sent by the terminal. In this embodiment, after S1708 is performed, S1709 to S1611 are performed.

In a second implementation, if the third indication information is used to indicate that the feedback of the terminal is required for the NBIFOM container sent by the SGSN, or the third indication information is used to instruct the SGSN to send the NBIFOM container to the terminal by using the request message, in this embodiment, after S1707 is performed, the following operations S1709 to S1711 are performed.

Operation S1709. The SGSN sends, according to the third indication information, a modify PDP context request message carrying the NBIFOM container including the K routing rules to the terminal.

In this embodiment, the SGSN sends the NBIFOM container including the K routing rules to the terminal by using the modify PDP context request.

Operation S1710. The terminal sends a modify PDP context response message carrying routing rule acknowledgement indication information to the SGSN.

The routing rule acknowledgement indication information includes first indication information or second indication information, the first indication information is used to indicate that the terminal accepts the K routing rules, and the second indication information is used to indicate that the terminal rejects at least one of the K routing rules.

Operation S1711. The SGSN sends an update bearer response message carrying the routing rule acknowledgement indication information to the PGW.

In this embodiment, the PGW receives the update bearer response message sent by the SGSN, obtains the routing rule acknowledgement indication information in the update bearer response message, determines, according to the routing rule acknowledgement indication information, a routing rule accepted by the terminal, and transmits a traffic flow by using the routing rule accepted by the terminal. This ensures consistency of routing rules used by the gateway device and the terminal, and ensures correct transmission of the traffic flow.

Optionally, the update bearer request message in S1707 may be a create bearer request message; correspondingly, the modify PDP context request message in S1709 may be a request secondary PDP context activation message; the modify PDP context response message in S1710 may be an activate secondary PDP context request message; and the update bearer response message in S1711 may be a create bearer response message.

Optionally, the PGW may be replaced with an SGW.

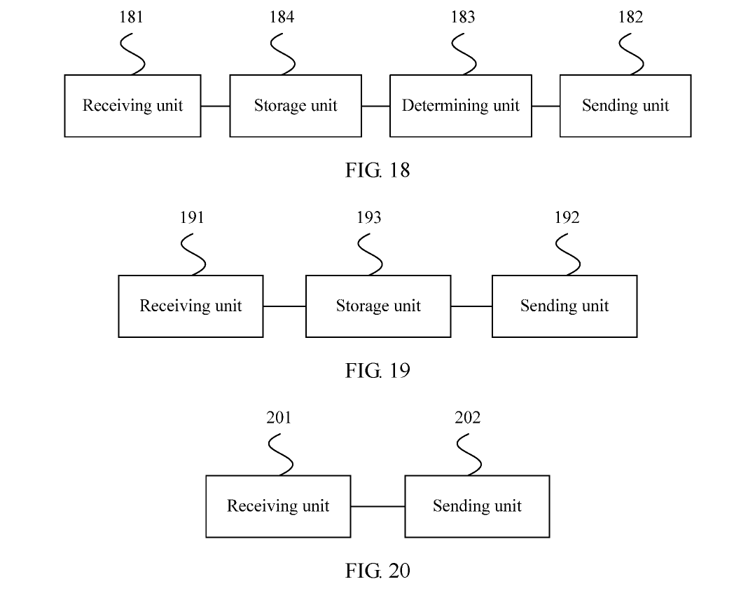

FIG. 18 is a schematic structural diagram of an intermediate network device according to Embodiment 3 of the present application. As shown in FIG. 18, the intermediate network device in this embodiment may include a receiving unit 181 and a sending unit 182.

The receiving unit 181 is configured to receive an NBIFOM routing rule request sent by a terminal.

The sending unit 182 is configured to send the NBIFOM routing rule request received by the receiving unit 181 to a gateway device.

The receiving unit 181 is further configured to receive an NBIFOM container including K routing rules and sent by the gateway device according to the NBIFOM routing rule request, where K is an integer greater than or equal to 1.

The sending unit 182 is further configured to send the NBIFOM container including the K routing rules and received by the receiving unit 181 to the terminal.

The receiving unit 181 is further configured to receive routing rule acknowledgement indication information sent by the terminal, where the routing rule acknowledgement indication information includes first indication information or second indication information, the first indication information is used to indicate that the terminal accepts the K routing rules, and the second indication information is used to indicate that the terminal rejects at least one of the K routing rules.

The sending unit 182 is further configured to send the routing rule acknowledgement indication information received by the receiving unit 181 to the gateway device.

Optionally, the intermediate network device in this embodiment may further include a determining unit 183.

In one embodiment, after the receiving unit 181 receives the NBIFOM routing rule request sent by the terminal, the determining unit 183 is configured to determine whether third indication information is received from the gateway device, where the third indication information is used to instruct the intermediate network device to send an acknowledgement message that does not carry any routing rule to the terminal; and if the determining unit 183 determines that the third indication information is received from the gateway device, the sending unit 182 is further configured to send an acknowledgement message to the terminal, where the acknowledgement message does not carry the NBIFOM container including the K routing rules, and the acknowledgement message is used to acknowledge reception of the NBIFOM routing rule request sent by the terminal.

In another embodiment, the determining unit 183 is configured to determine whether third indication information is received from the gateway device, where the third indication information is used to indicate that a feedback of the terminal is required for an NBIFOM container sent by the intermediate network device, or the third indication information is used to instruct the intermediate network device to send an NBIFOM container to the terminal by using a request message; and if the determining unit 183 determines that the third indication information is received from the gateway device, the sending unit 182 is further configured to send a first request message to the terminal, where the first request message carries the NBIFOM container including the K routing rules.

Optionally, the first request message is a request secondary PDP context activation message or a modify PDP context request message.

Optionally, the sending unit 182 is further configured to send an acknowledgement message to the terminal, where the acknowledgement message does not carry the NBIFOM container including the K routing rules, and the acknowledgement message is used to acknowledge reception of the NBIFOM routing rule request sent by the terminal.

Optionally, the receiving unit 181 is further configured to receive the third indication information from the gateway device.

Optionally, the third indication information and the NBIFOM container including the K routing rules are both carried in a create bearer request message or an update bearer request message; or the third indication information is carried in a create session response message, and the NBIFOM container including the K routing rules is carried in a create bearer request message or an update bearer request message.

Optionally, the intermediate network device in this embodiment may further include a storage unit 184, where after the receiving unit 181 receives the third indication information from the gateway device, the storage unit 184 is configured to store the third indication information received by the receiving unit 181.

Optionally, the NBIFOM routing rule request includes an NBIFOM container.

The intermediate network device in this embodiment may be configured to execute the technical solution executed by the intermediate network device in the foregoing method embodiment of the present application shown in FIG. 13, or FIG. 16A and FIG. 16B, or FIG. 17A and FIG. 17B. An implementation principle and a technical effect thereof are similar, and are not further described herein.

FIG. 19 is a schematic structural diagram of a gateway device according to Embodiment 3 of the present application. As shown in FIG. 19, the gateway device in this embodiment may include a receiving unit 191 and a sending unit 192. The receiving unit 191 is configured to receive an NBIFOM routing rule request, where the NBIFOM routing rule request includes a routing rule generation parameter of a terminal. The sending unit 192 is configured to send, according to the NBIFOM routing rule request received by the receiving unit 191, third indication information and an NBIFOM container including K routing rules to an intermediate network device.

K is an integer greater than or equal to 1, and the third indication information is used to instruct the intermediate network device to send an acknowledgement message that does not carry any routing rule to the terminal, or the third indication information is used to indicate that a feedback of the terminal is required for an NBIFOM container sent by the intermediate network device, or the third indication information is used to instruct the intermediate network device to send an NBIFOM container to the terminal by using a request message.

Optionally, when sending the third indication information to the intermediate network device, the sending unit 192 is specifically configured to send the third indication information to the intermediate network device if a PDN connection of the terminal is in a network-initiated NBIFOM mode.

Optionally, the network device in this embodiment may further include a storage unit 193;

before receiving the NBIFOM routing rule request, the receiving unit 191 is further configured to receive mode indication information sent by a PCRF, where the mode indication information is used to indicate the mode of the PDN connection of the terminal; and the storage unit 193 is configured to store the mode indication information received by the receiving unit 191.

Optionally, the third indication information and the K routing rules are carried in a create bearer request message or an update bearer request message.

The gateway device in this embodiment may be configured to execute the technical solution executed by the gateway device in the foregoing method embodiment shown in FIG. 14, or FIG. 16A and FIG. 16B, or FIG. 17A and FIG. 17B. An implementation principle and a technical effect thereof are similar, and are not further described herein.

FIG. 20 is a schematic structural diagram of a gateway device according to Embodiment 4 of the present application. As shown in FIG. 20, the gateway device in this embodiment may include a receiving unit 201 and a sending unit 202. The receiving unit 201 is configured to receive mode indication information sent by a PCRF, where the mode indication information is used to indicate a mode of a PDN connection of a terminal. The sending unit 202 is configured to send third indication information to an intermediate network device if the mode indication information received by the receiving unit 201 indicates that the PDN connection of the terminal is in a network-initiated NBIFOM mode, where the third indication information is used to instruct the intermediate network device to send an acknowledgement message that does not carry any routing rule to the terminal, or the third indication information is used to indicate that a feedback of the terminal is required for an NBIFOM container sent by the intermediate network device, or the third indication information is used to instruct the intermediate network device to send an NBIFOM container to the terminal by using a request message.

The receiving unit 201 is further configured to receive an NBIFOM routing rule request.

The sending unit 202 is further configured to send, according to the NBIFOM routing rule request received by the receiving unit 201, an NBIFOM container including K routing rules to the intermediate network device, where K is an integer greater than or equal to 1.

Optionally, the third indication information is carried in a create session response message and sent to the intermediate network device.

The gateway device in this embodiment may be configured to execute the technical solution executed by the gateway device in the foregoing method embodiment shown in FIG. 15, or FIG. 16A and FIG. 16B, or FIG. 17A and FIG. 17B. An implementation principle and a technical effect thereof are similar, and are not further described herein.

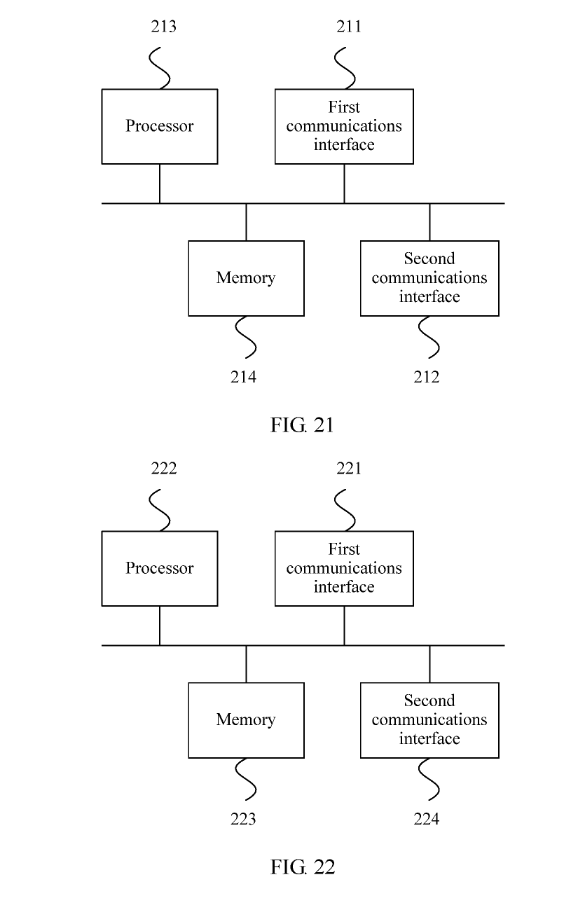

FIG. 21 is a schematic structural diagram of an intermediate network device according to Embodiment 4 of the present application. As shown in FIG. 21, the intermediate network device in this embodiment may include a first communications interface 211, a second communications interface 212, a processor 213, and a memory 214. The memory 214 is configured to store program code for performing a method for routing rule transmission. The processor 213 is configured to invoke the program code in the memory 214 to perform:

receiving, by using the first communications interface 211, an NBIFOM routing rule request sent by a terminal, and sending the NBIFOM routing rule request to a gateway device by using the second communications interface 212; receiving, by using the second communications interface 212, an NBIFOM container including K routing rules and sent by the gateway device, and sending, by using the first communications interface 211, the NBIFOM container including the K routing rules to the terminal, where K is an integer greater than or equal to 1; and receiving, by using the first communications interface 211, routing rule acknowledgement indication information sent by the terminal, and sending the routing rule acknowledgement indication information to the gateway device by using the second communications interface 212, where the routing rule acknowledgement indication information includes first indication information or second indication information, the first indication information is used to indicate that the terminal accepts the K routing rules, and the second indication information is used to indicate that the terminal rejects at least one of the K routing rules.

Optionally, after receiving, by using the first communications interface 211, the NBIFOM routing rule request sent by the terminal, the processor 213 is further configured to: determine whether third indication information is received from the gateway device, where the third indication information is used to instruct the intermediate network device to send an acknowledgement message that does not carry any routing rule to the terminal; and if determining that the third indication information is received from the gateway device, send an acknowledgement message to the terminal by using the first communications interface 211, where the acknowledgement message does not carry the NBIFOM container including the K routing rules, and the acknowledgement message is used to acknowledge reception of the NBIFOM routing rule request sent by the terminal.

Optionally, the processor 213 is further configured to determine whether third indication information is received from the gateway device, where the third indication information is used to indicate that a feedback of the terminal is required for an NBIFOM container sent by the intermediate network device, or the third indication information is used to instruct the intermediate network device to send an NBIFOM container to the terminal by using a request message; and when sending, by using the first communications interface 211, the NBIFOM container including the K routing rules to the terminal, the processor 213 is specifically configured to send a first request message to the terminal by using the first communications interface 211 if determining that the third indication information is received from the gateway device, where the first request message carries the NBIFOM container including the K routing rules.

Optionally, the first request message is a request secondary packet data protocol PDP context activation message or a modify PDP context request message.

Optionally, the processor 213 is further configured to send an acknowledgement message to the terminal by using the first communications interface 211, where the acknowledgement message does not carry the NBIFOM container including the K routing rules, and the acknowledgement message is used to acknowledge reception of the NBIFOM routing rule request sent by the terminal.

Optionally, the processor 213 is further configured to receive the third indication information from the gateway device by using the second communications interface 212.

Optionally, the third indication information and the NBIFOM container including the K routing rules are both carried in a create bearer request message or an update bearer request message; or the third indication information is carried in a create session response message, and the NBIFOM container including the K routing rules is carried in a create bearer request message or an update bearer request message.

Optionally, after receiving the third indication information from the gateway device by using the second communications interface 212, the processor 213 is further configured to store the third indication information.

Optionally, the NBIFOM routing rule request includes an NBIFOM container.

The intermediate network device in this embodiment may be configured to execute the technical solution executed by the intermediate network device in the foregoing method embodiment of the present application shown in FIG. 13, or FIG. 16A and FIG. 16B, or FIG. 17A and FIG. 17B. An implementation principle and a technical effect thereof are similar, and are not further described herein.

FIG. 22 is a schematic structural diagram of a gateway device according to Embodiment 5 of the present application. As shown in FIG. 22, the gateway device in this embodiment may include a first communications interface 221, a processor 222, and a memory 223. The memory 223 is configured to store program code for performing a method for routing rule transmission. The processor 222 is configured to invoke the program code in the memory 223 to perform:

receiving an NBIFOM routing rule request by using the first communications interface 221; and sending, according to the NBIFOM routing rule request, third indication information and an NBIFOM container including K routing rules to an intermediate network device by using the first communications interface 221.

K is an integer greater than or equal to 1, and the third indication information is used to instruct the intermediate network device to send an acknowledgement message that does not carry any routing rule to the terminal, or the third indication information is used to indicate that a feedback of the terminal is required for an NBIFOM container sent by the intermediate network device, or the third indication information is used to instruct the intermediate network device to send an NBIFOM container to the terminal by using a request message.

Optionally, when sending the third indication information to the intermediate network device by using the first communications interface 221, the processor 222 is specifically configured to send the third indication information to the intermediate network device by using the first communications interface 221 if a PDN connection of the terminal is in a network-initiated NBIFOM mode.

Optionally, the gateway device in this embodiment further includes a second communications interface 224; and

before receiving the NBIFOM routing rule request by using the first communications interface 221, the processor 222 is further configured to: receive, by using the second communications interface 224, mode indication information sent by a PCRF, where the mode indication information is used to indicate the mode of the PDN connection of the terminal; and store the mode indication information.

Optionally, the third indication information and the K routing rules are carried in a create bearer request message or an update bearer request message.

The gateway device in this embodiment may be configured to execute the technical solution executed by the gateway device in the foregoing method embodiment shown in FIG. 14, or FIG. 16A and FIG. 16B, or FIG. 17A and FIG. 17B. An implementation principle and a technical effect thereof are similar, and are not further described herein.

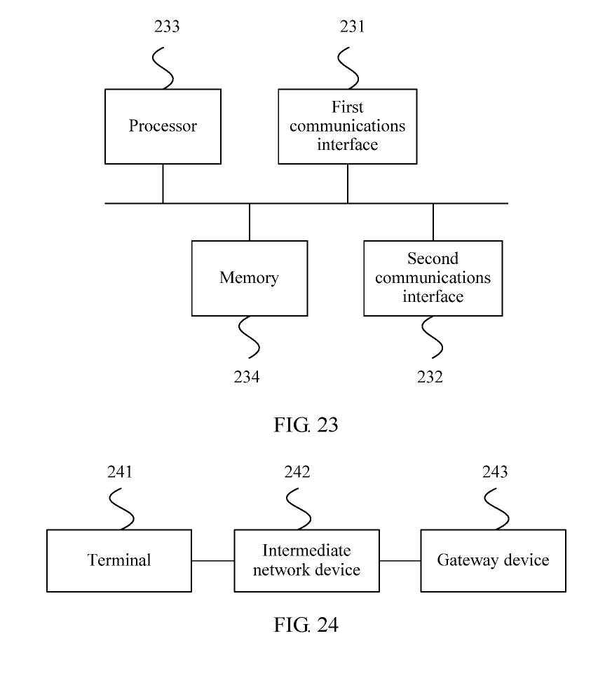

FIG. 23 is a schematic structural diagram of a gateway device according to Embodiment 6 of the present application. As shown in FIG. 23, the gateway device in this embodiment may include a first communications interface 231, a second communications interface 232, a processor 233, and a memory 234. The memory 234 is configured to store program code for performing a method for routing rule transmission. The processor 233 is configured to invoke the program code in the memory 234 to perform:

receiving, by using the first communications interface 231, mode indication information sent by a PCRF, where the mode indication information is used to indicate a mode of a PDN connection of a terminal; if the mode indication information indicates that the PDN connection of the terminal is in a network-initiated NBIFOM mode, sending third indication information to an intermediate network device by using the second communications interface 232, where the third indication information is used to instruct the intermediate network device to send an acknowledgement message that does not carry any routing rule to the terminal, or the third indication information is used to indicate that a feedback of the terminal is required for an NBIFOM container sent by the intermediate network device, or the third indication information is used to instruct the intermediate network device to send an NBIFOM container to the terminal by using a request message; receiving an NBIFOM routing rule request by using the second communications interface 232; and sending, according to the NBIFOM routing rule request, an NBIFOM container including K routing rules to the intermediate network device by using the second communications interface 232.

Optionally, the third indication information is carried in a create session response message and sent to the intermediate network device.

The gateway device in this embodiment may be configured to execute the technical solution executed by the gateway device in the foregoing method embodiment shown in FIG. 15, or FIG. 16A and FIG. 16B, or FIG. 17A and FIG. 17B. An implementation principle and a technical effect thereof are similar, and are not further described herein.

FIG. 24 is a schematic structural diagram of a system for routing rule transmission according to Embodiment 2 of the present application. As shown in FIG. 24, the system in this embodiment includes a terminal 241, an intermediate network device 242, and a gateway device 243. The terminal 241 may use a structure of the terminal provided by Embodiment 1 or Embodiment 2 of the present application, and the terminal 241 may correspondingly execute the technical solution executed by the terminal in each of the foregoing method embodiments of the present application. An implementation principle and a technical effect thereof are similar, and are not further described herein. The intermediate network device 242 may use a structure of the intermediate network device provided by Embodiment 3 or Embodiment 4 of the present application, and the intermediate network device 242 may correspondingly execute the technical solution executed by the intermediate network device in each of the foregoing method embodiments of the present application. An implementation principle and a technical effect thereof are similar, and are not further described herein. The gateway device 243 may use a structure of the gateway device shown in any one of Embodiment 3 to Embodiment 6 of the present application, and the gateway device 243 may correspondingly execute the technical solution executed by the gateway device in each of the foregoing method embodiments of the present application. An implementation principle and a technical effect thereof are similar, and are not further described herein. It should be noted that, the terminal 241 communicates with the intermediate network device 242 through an access network (not shown in the figure). Depending on different access networks, the intermediate network device 242 also varies correspondingly.

Persons of ordinary skill in the art may understand that all or a part of the operations of the method embodiments may be implemented by a program instructing relevant hardware. The program may be stored in a computer readable storage medium. When the program runs, the steps of the method embodiments are performed. The foregoing storage medium includes: any medium that can store program code, such as a read-only memory (ROM), a random access memory (RAM), a magnetic disk, or an optical disc.

Finally, it should be noted that the foregoing embodiments are merely intended for describing the technical solutions of the present application, but not for limiting the present application. Although the present application is described in detail with reference to the foregoing embodiments, persons of ordinary skill in the art should understand that they may still make modifications to the technical solutions described in the foregoing embodiments or make equivalent replacements to some or all technical features thereof, without departing from the scope of the technical solutions of the embodiments of the present application.

What is claimed is:

1. A method for routing rule transmission, comprising:
receiving, by an intermediate network device, a network based IP flow mobility (NBIFOM) routing rule request from a terminal, and sending the NBIFOM routing rule request to a gateway device;
receiving, by the intermediate network device, an NBIFOM container containing K routing rules from the gateway device, and sending the NBIFOM container having the K routing rules to the terminal, wherein K is an integer greater than or equal to 1; and
receiving, by the intermediate network device, routing rule acknowledgement indication information from the terminal, and sending the routing rule acknowledgement indication information to the gateway device, wherein the routing rule acknowledgement indication information comprises first indication information or second indication information, wherein the first indication information is used to indicate that the terminal accepts the K routing rules, and wherein the second indication information is used to indicate that the terminal rejects at least one of the K routing rules.

2. The method according to claim 1, wherein the sending, by the intermediate network device, the NBIFOM container having the K routing rules to the terminal comprises:
if third indication information is received from the gateway device, sending, by the intermediate network device, a first request message to the terminal, wherein the first request message includes the NBIFOM container having the K routing rules, and wherein the third indication information is used to instruct the intermediate network device to send an NBIFOM container to the terminal using a request message.

3. The method according to claim 2, wherein the first request message is a request secondary packet data protocol (PDP) context activation message or a modify PDP context request message.

4. The method according to claim 2, wherein the method further comprises:
receiving, by the intermediate network device, the third indication information from the gateway device.

5. The method according to claim 4, wherein the third indication information is carried in a create session response message, and the NBIFOM container containing the K routing rules is carried in a create bearer request message or an update bearer request message.

6. The method according to claim 4, wherein after the receiving, by the intermediate network device, the third indication information from the gateway device, the method further comprises:
storing, by the intermediate network device, the third indication information.

7. The method according to claim 1, wherein the method further comprises:
sending, by the intermediate network device, an acknowledgement message to the terminal, wherein the acknowledgement message does not carry the NBIFOM container containing the K routing rules, and the acknowledgement message is used to acknowledge reception of the NBIFOM routing rule request sent by the terminal.

8. A method for routing rule transmission, comprising:
receiving, by a gateway device, mode indication information from a policy and charging rules function (PCRF), wherein the mode indication information is used to indicate a mode of a packet data network (PDN) connection of a terminal;
when the mode indication information indicates that the PDN connection of the terminal is in a network-initiated network based IP flow mobility (NBIFOM) mode, sending, by the gateway device, third indication information to an intermediate network device, wherein the third indication information is used to instruct the intermediate network device to send an NBIFOM container to the terminal using a request message;
receiving, by the gateway device, an NBIFOM routing rule request; and
sending, by the gateway device according to the NBIFOM routing rule request, an NBIFOM container containing K routing rules to the intermediate network device, wherein K is an integer greater than or equal to 1.

9. The method according to claim 8, wherein the third indication information is carried in a create session response message and sent to the intermediate network device.

10. An intermediate network device, comprising a first communications interface, a second communications interface, a processor, and a memory, wherein
the memory is configured to store program code for performing a method for routing rule transmission; and
the processor is configured to invoke the program code in the memory to perform:
receiving, via the first communications interface, a network based IP flow mobility (NBIFOM) routing rule request from a terminal, and sending the NBIFOM routing rule request to a gateway device by using the second communications interface;
receiving, via the second communications interface, an NBIFOM container containing K routing rules from the gateway device, and sending, using the first communications interface, the NBIFOM container containing the K routing rules to the terminal, wherein K is an integer greater than or equal to 1; and
receiving, via the first communications interface, routing rule acknowledgement indication information from the terminal, and sending the routing rule acknowledgement indication information to the gateway device by using the second communications interface, wherein
the routing rule acknowledgement indication information comprises first indication information or second indication information, wherein the first indication information is used to indicate that the terminal accepts the K routing rules, and wherein the second indication information is used to indicate that the terminal rejects at least one of the K routing rules.

11. The intermediate network device according to claim 10, wherein the processor is further configured to determine whether third indication information is received from the gateway device, wherein the third indication information is used to instruct the intermediate network device to send an NBIFOM container to the terminal by using a request message; and
when sending, by using the first communications interface, the NBIFOM container containing the K routing rules to the terminal, the processor is further configured to send a first request message to the terminal via the first communications interface if it is determined that the third indication information is received from the gateway device, wherein the first request message includes the NBIFOM container having the K routing rules.

12. The intermediate network device according to claim 11, wherein the first request message is a request secondary packet data protocol (PDP) context activation message or a modify PDP context request message.

13. The intermediate network device according to claim 11, wherein the processor is further configured to receive the third indication information from the gateway device by using the second communications interface.

14. The intermediate network device according to claim 13, wherein the third indication information is carried in a create session response message, and the NBIFOM container containing the K routing rules is carried in a create bearer request message or an update bearer request message.

15. The intermediate network device according to claim 13, wherein after receiving the third indication information from the gateway device via the second communications interface, the processor is further configured to store the third indication information.

16. The intermediate network device according to claim 10, wherein the processor is further configured to send an acknowledgement message to the terminal via the first communications interface, wherein the acknowledgement message does not carry the NBIFOM container comprising the K routing rules, and the acknowledgement message is used to acknowledge reception of the NBIFOM routing rule request sent by the terminal.

17. A gateway device, comprising a first communications interface, a second communications interface, a processor, and a memory, wherein
the memory is configured to store program code for performing a method for routing rule transmission; and
the processor is configured to invoke the program code in the memory to perform:
receiving, via the first communications interface, mode indication information from a policy and charging rules function (PCRF), wherein the mode indication information is used to indicate a mode of a packet data network (PDN) connection of a terminal;
when the mode indication information indicates that the PDN connection of the terminal is in a network-initiated network based IP flow mobility (NBIFOM) mode, sending third indication information to an intermediate network device via the second communications interface, wherein the third indication information is used to instruct the intermediate network device to send an NBIFOM container to the terminal using a request message;
receiving an NBIFOM routing rule request via the second communications interface; and
sending, according to the NBIFOM routing rule request, an NBIFOM container containing K routing rules to the intermediate network device via the second communications interface, wherein K is an integer greater than or equal to 1.

18. The gateway device according to claim 17, wherein the third indication information is carried in a create session response message and sent to the intermediate network device.
